(19) United States
(12) Patent Application Publication
(10) Pub. No.: US 2022/0114994 A1
(43) Pub. Date: Apr. 14, 2022

(54) SYSTEMS, DEVICES, AND METHODS FOR GENERATING SYMBOL SEQUENCES AND FAMILIES OF SYMBOL SEQUENCES

(71) Applicant: Obeebo Labs Ltd., Petaluma, CA (US)

(72) Inventors: Colin P. Williams, Half Moon Bay, CA (US); Gregory Gabrenya, Petaluma, CA (US)

(21) Appl. No.: 17/555,339

(22) Filed: Dec. 17, 2021

Related U.S. Application Data
(60) Provisional application No. 63/128,029, filed on Dec. 19, 2020.

(51) Int. Cl. G10H 1/00; G06N 10/20; G06N 10/60

(52) U.S. Cl. CPC G10H 1/0025; G06N 10/20; G10H 2250/135; G10H 2210/111; G06N 10/60

(57) ABSTRACT

The present systems, devices, and methods generally relate to generating families of symbol sequences with controllable degree of correlation within and between them using quantum computers, and particularly to the exploitation of this capability to generate families of symbol sequences representing musical events such as, but not limited to, musical notes, musical chords, musical percussion strikes, musical time intervals, musical note intervals, and musical key changes that comprise a musical composition. Quantum random walks on graphs representing allowed transitions between musical events are also employed in some implementations.

### TECHNICAL FIELD

The present systems, devices, and methods generally relate to generating families of symbol sequences with controllable degree of correlation within and between them using quantum computers, and particularly to the exploitation of this capability to generate families of symbol sequences representing musical events.

### BACKGROUND

A sequence is understood to be a set of related events, movements, or symbols that follow each other in a particular order. Heretofore, such sequences have been represented as ordered arrangements of classical symbols, resulting in classical sequences. An example of such a classical sequence is the sequence of musical notes or percussion strikes that comprise a single track within a musical composition.

A “family” of sequences is understood to be a multiplicity of sequences that are typically related to one another in some manner, such as being synchronized in time, aligned ordinally, or otherwise correlated to some degree. Heretofore, such families of sequences have been represented as ordered arrangements of classical sequences, each comprising its own sequence of classical symbols. An example of such a family of classical sequences is the set of music tracks, each comprising its own sequence of musical notes or percussion strikes, that collectively comprise a single, coherent, aesthetically pleasing musical composition.

While a classical sequence can exhibit correlations between the symbols occurring at one or more positions within it, and while a multiplicity of such classical sequences can exhibit correlations between the symbols occurring at one or more positions within them, the degree of correlation that is attainable between such symbols in such a sequence, or between such symbols in such a multiplicity of sequences, is necessarily limited to that allowed by the laws of classical physics. This limitation is fundamental and applies to all prior art related to sequences, and families of sequences, encoded in classical information, i.e., encoded in unambiguously distinguishable, unchanging when read, conventional (classical) symbols.

### BRIEF SUMMARY

A method to generate a symbol sequence, or a multiplicity of related symbol sequences, may be summarized as including: a data object describing a desired correlation structure between a set of symbols; an invertible mapping from quantum states to said symbols; a quantum circuit comprising a sequence of single qubit and multi-qubit quantum gates, which embodies the desired correlation structure contained in said data object; an input quantum state encoding an initial symbol from the set of symbols, together with a standard starting state for the remaining qubits; an output quantum state obtained by running the quantum computation embodied in said quantum circuit upon said input quantum state; a method to read the values of the qubits in said output quantum state; and a method to interpret the values of the qubits in said output state as a sequence of symbols.

Multiple implementations of the foregoing method are described, including implementations that vary according to (a) whether the data object specifying the correlation structure of the symbol sequence is given explicitly (as either a unitary matrix, suitable for quantum computing, or as an arbitrary matrix, which is suitable for specifying arbitrary stochastic processes, or implicitly (as a training set of exemplary symbol sequences), (b) the type of quantum state fed into the quantum symbol sequence generator, (c) whether the output quantum state (prior to measurement) is a superposition of the desired symbol sequence realizations unconditionally, or whether the output quantum state (prior to measurement) is a superposition of the desired symbol sequence realizations conditioned upon a certain ancilla qubit (e.g., the first k qubit(s) of the output for some integer k) being found to be in a certain state, and (d) the choice of basis or bases in which to read the output qubits.

Specific illustrative implementations are described that specialize the methods to stochastic processes in which the i-th symbol depends on only the previous symbol, or only a previous subset of symbols (i.e., a subset of indexed symbols who indices are less than i), or on both a subset of past and a subset of future symbols (i.e., a subset of indexed symbols whose indices are greater than i), or in which the underlying stochastic process in non-stationary, or in which there are a multiplicity of coupled stochastic processes.

A system for generating symbol sequences may be summarized as including: a quantum computer, one or more auxiliary classical computers, and communications equipment connecting them; a means to input a desired map from binary numbers (or indeed any base numbers) to symbols; a means to input a data object describing a desired correlation structure between a set of symbols explicitly, or to input a data object describing a desired correlation structure between a set of symbols implicitly as a set of exemplary symbol sequences; a computer algorithm running on said one or more classical computers to infer a quantum circuit sufficient to embody the correlations between symbols defined in said data object; a computer algorithm running on said one or more classical computers to infer an initial quantum state corresponding to a desired initial single symbol, or initial multiplicity of symbols; a means to communicate of quantum computer program to said quantum computer to cause it to be configured to run said quantum circuit; a means to communicate said initial quantum state to said quantum computer configured to run said quantum circuit; a means to communicate a desired set of measurements on the quantum state output from said quantum computer running said quantum circuit on said input quantum state; a means to communicate the results of said measurements to said one or more classical computers; and a means to interpret said measurement outcomes as a symbol sequence.

The foregoing system allows for the possibility that the quantum computer and auxiliary classical computers might be local to each other, or instead connected over an internet connection.

A hybrid computer program/quantum computer program product for generating symbol sequences may be summarized as including: a program for mapping binary numbers to symbols; a program for mapping symbols to binary numbers; a program for inferring a data object describing a desired correlation structure between a set of symbols, or learning a data object describing a desired correlation structure between a set of symbols, from a set of exemplary training examples of desirable symbol sequences; a program for determining the quantum circuit, i.e., the sequence of quantum gates, and any parameters required therein, sufficient to embody said data object describing a desired correlation structure between a set of symbols; a program for determining an initial quantum state corresponding to a desired initial single symbol, or initial multiplicity of symbols; and a program to interpret the output from the said quantum computer, post-measurement, as an equivalent symbol sequence.

A method to generate a sequence of symbols from a set of symbols may be summarized as including: defining a correlation structure between symbols in the set of symbols; defining a mapping between quantum states and symbols in the set of symbols; embodying the correlation structure in a quantum circuit; inputting an initial quantum state to the quantum circuit; running the quantum circuit; reading out a final quantum state; and applying the mapping between quantum states and symbols to obtain the symbol sequence. Embodying the correlation structure in a quantum circuit may include embodying the correlation structure in a quantum circuit described, at least in part, by a unitary matrix. The method may be performed by a computer system comprising at least one processor and at least one quantum computer communicatively coupled to the at least one processor, wherein: defining a correlation structure between symbols in the set of symbols includes defining the correlation structure by the at least one processor; defining a mapping between quantum states and symbols in the set of symbols includes defining the mapping by the at least one processor; embodying the correlation structure in a quantum circuit includes embodying the correlation structure in the quantum circuit by the quantum computer; inputting an initial quantum state to the quantum circuit includes inputting the initial quantum state to the quantum circuit by the quantum computer; running the quantum circuit includes running the quantum circuit by the quantum computer; reading out a final quantum state includes reading out the final quantum state by the quantum computer; and applying the mapping between quantum states and symbols to obtain the symbol sequence includes applying the mapping between quantum states and symbols by the at least one processor.

Inputting an initial quantum state to the quantum circuit may include inputting an initial quantum state that represents an initial symbol from the set of symbols according to the mapping. Inputting an initial quantum state that represents an initial symbol from the set of symbols according to the mapping may include inputting a tensor product between the initial symbol from the set of symbols and a starting state.

Defining a correlation structure between symbols in the set of symbols may include learning the correlation structure from a training set of exemplary symbol sequences. Defining a correlation structure between symbols in the set of symbols may include defining the correlation structure as a unitary matrix, wherein embodying the correlation structure in a quantum circuit includes embodying the correlation structure in a sequence of single qubit and multi-qubit quantum gates that embodies the unitary matrix. Reading out a final quantum state may include reading out the final quantum state in the computational basis.

The set of symbols may include a set of musical events. The set of symbols may include at least one musical event selected from a group consisting of: a musical note, a musical chord, a musical percussion strike, a musical time interval, a musical note interval, and a musical key. Defining a correlation structure between symbols in the set of symbols may include defining a correlation structure between musical events in the set of musical events. Defining a mapping between quantum states and symbols in the set of symbols may include defining a mapping between quantum states and musical events in the set of musical events. Applying the mapping between quantum states and symbols to obtain the symbol sequence may include applying the mapping between quantum states and musical events to obtain a sequence of musical events. The set of musical events may include a set of musical chords, and applying the mapping between quantum states and musical events to obtain a sequence of musical events may include applying the mapping between quantum states and musical events to obtain a musical chord progression. The set of musical events may include a set of musical keys, and applying the mapping between quantum states and musical events to obtain a sequence of musical events may include applying the mapping between quantum states and musical events to obtain a sequence of musical key modulations. Defining a correlation structure between symbols in the set of symbols may include defining a graph with each node corresponding to a respective musical event and each edge corresponding to a respective allowed transition between a respective pair of musical events, and running the quantum circuit may include performing a quantum walk process on the graph. Applying the mapping between quantum states and symbols to obtain the symbol sequence may include applying the mapping between quantum states and musical events to obtain a sequence of musical events corresponding to a walk process that starts at a musical event corresponding to the initial quantum state and progresses to successive musical events following allowed transitions according to the edges of the graph.

A computer system may be summarized as including: at least one processor; at least one quantum computer communicatively coupled to the at least one processor; and a non-transitory processor-readable storage medium communicatively coupled to the at least one processor, the non-transitory processor-readable storage medium storing a set of symbols and processor-executable instructions that, when executed by the at least one processor, cause the computer system to: embody a correlation structure between symbols in the set of symbols in a quantum circuit; input an initial quantum state to the quantum circuit; run the quantum circuit; read out a final quantum state; and apply a mapping between quantum states and symbols in the set of symbols to obtain a symbol sequence. The set of symbols may include a set of musical events and the processor-executable instructions that, when executed by the at least one processor, cause the computer system to apply a mapping between quantum states and symbols in the set of symbols to obtain a symbol sequence, may cause the computer system to apply the mapping between quantum states and musical events to obtain a sequence of musical events. The processor-executable instructions that, when executed by the at least one processor, cause the computer system to embody a correlation structure between symbols in the set of symbols in a quantum circuit, may cause the computer system to embody the correlation structure between musical events in a quantum circuit described, at least in part, by a unitary matrix.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a flow diagram showing an exemplary method of generating a symbol sequence using a quantum computer in accordance with the present systems, devices, and methods.

FIG. 2 shows an exemplary quantum circuit, together with a set of inputs and measurement operations on outputs, that is capable of generating symbol sequences in accordance with the present systems, devices, and methods. The structure and/or values of the parameters of such a quantum circuit might be provided, inferred, or learned via a training procedure.

FIG. 3 shows an exemplary quantum circuit derived from an underlying arbitrary matrix, together with a set of inputs and measurement operations on outputs, that is capable of generating symbol sequences conditional on the result obtained by measuring single qubit, or a subset of qubits, in accordance with the present systems, devices, and methods. The structure and/or values of the parameters of such a quantum circuit might be provided, inferred, or learned via a training procedure.

FIG. 4 & FIG. 5 collectively show an exemplary realization of the process described in FIG. 3 in accordance with the present systems, devices, and methods.

FIG. 6 shows how the structure of a repeated quantum sub-circuit (deployed in FIG. 7) is related to the direct sum of a multiplicity of smaller unitary matrices in accordance with the present systems, devices, and methods.

FIG. 7 shows an exemplary instance of a specially structured quantum circuit that contains a repeated quantum sub-circuit (from FIG. 6) arranged in a staggered cascading pattern across the input qubits, which is capable of generating symbol sequences in which the value of a particular symbol (encoded in binary) depends on one its preceding symbol (encoded in binary) in accordance with the present systems, devices, and methods.

FIG. 8 shows an exemplary quantum circuit for three (3) steps of a stochastic process in which each successive symbol depends on the two immediately preceding symbols, each having one of 4 possible values, in accordance with the present systems, devices, and methods.

FIG. 9 shows an exemplary quantum circuit for three (3) steps of a non-stationary stochastic process in which successive families of controlled gates change due to a changing (i.e., non-stationary) underlying probability transition matrix as the process evolves, in accordance with the present systems, devices, and methods.

FIG. 10 shows an exemplary quantum circuit for three (3) steps of a pair of (tunably) correlated stochastic processes, each over an alphabet of four (4) symbols (which may or may not be the same alphabets), in which the same control variables are used to determine two (or more) symbol sequences, in accordance with the present systems, devices, and methods. Even though the control qubits are, in this case, common to both tracks the probability transition matrices they drive (implemented as Controlled-U and Controlled-V gates in the exemplary case) need not be the same.

FIG. 11 shows an exemplary quantum circuit for four (4) steps of a stochastic process over an alphabet of four (4) symbols in which the value of each successive symbol depends on past and/or future symbols in the sequence, rather than exclusively on past symbols in the sequence, in accordance with the present systems, devices, and methods.

FIG. 12 is an illustrative diagram of an exemplary computer-based symbol sequence generation system suitable at a high level for performing the various computer-implemented methods described in the present systems, devices, and methods.

FIG. 13 shows the notional structure for an exemplary parameterized quantum circuit that can be trained to generate music in accordance with the present systems, devices, and methods.

FIG. 14 is an illustrative diagram of a chord graph upon which a quantum or classical walk may be performed showing available chord progressions for major and minor triad chords allowing parallel (P), relative (R), and leading-tone (L) transformation exchanges in accordance with the present systems, devices, and methods.

### DETAILED DESCRIPTION

The following description sets forth specific details in order to illustrate and provide an understanding of the various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

Unless the specific context requires otherwise, throughout this specification and the appended claims the terms “input state” and “output state” and variations thereof such as “input”, “input quantum state”, “input states”, “input quantum states”, “output”, “output quantum state”, “output states”, and “output quantum states”, can include any of the following (a) a single qubit, or multi-qubit, eigenket, (b) a single qubit, or multi-qubit, pure state (as described by some superposition), or (c) a single qubit, or multi-qubit, mixed state (as described by some density matrix).

Unless the specific context requires otherwise, throughout this specification and the appended claims the term “quantum circuit” and variations thereof such as “quantum circuits”, can include any of the following (a) a quantum circuit whose function is representable, equivalently, as a unitary matrix, (b) a quantum circuit whose function is representable, equivalently, as a unitary matrix, together with a set of ancilla qubits, (c) a quantum circuit whose function is representable, equivalently, as a non-unitary matrix in conjunction with a set of measurement operations, (d) a quantum circuit whose function is representable, equivalently, as a non-unitary matrix together with a set of ancilla qubits, in conjunction with a set of measurement operations, (e) a superoperator, or (f) a completely positive map.

The headings and Abstract of the Disclosure are provided for convenience only and are not intended, and should not be construed, to interpret the scope or meaning of the present systems, devices, and methods.

The various embodiments described herein provide systems, devices, and methods for generating families of symbol sequences with controllable degree of correlation within and between them using quantum computers, and particularly to the exploitation of this capability to generate sets of symbol sequences representing musical events.

The computer-based musical composition capability or system described herein may employ a wide range of techniques and/or algorithms for processing music. As examples, the computer-based musical composition systems described herein may employ any or all of: the systems, devices, and methods for encoding musical compositions in hierarchical data structures of the form Music[Segments{ }, barsPerSegment{ }] that are described in U.S. Pat. No. 10,629,176, filed Jun. 21, 2019 and entitled “Systems, Devices, and Methods for Digital Representations of Music”; the systems, devices, and methods for automatically identifying the musical segments of a musical composition that are described in U.S. Pat. No. 11,024,274, filed Jan. 28, 2020 and entitled “Systems, Devices, and Methods for Segmenting a Musical Composition into Musical Segments;” the systems, devices, and methods for identifying harmonic structure in digital data structures and for mapping the Music[Segments{ }, barsPerSegment{ }] data structure into an isomorphic HarmonicStructure[Segments{ }, harmonicSequencePerSegment{ }] data structure that are described in US Patent Publication No. 2020-0402488, filed Jan. 28, 2020 and entitled “Systems, Devices, and Methods for Harmonic Structure in Digital Representations of Music;” and/or any or all of the systems, devices, and methods described in U.S. Provisional Patent Application Ser. No. 62/968,963, filed Jan. 31, 2020 and entitled “Systems, Devices, and Methods for Computer-Generated Musical Compositions,” (now US Patent Publication Nos. 2021-0241733, 2021-0241734, 2021-0241735, and 2021-0241731). Additionally, the present systems, devices, and methods may employ the teachings of U.S. patent application Ser. No. 17/361,414, filed Jun. 29, 2021 and entitled “COMPUTER-BASED SYSTEMS, DEVICES, AND METHODS FOR GENERATING AESTHETIC CHORD PROGRESSIONS AND KEY MODULATIONS IN MUSICAL COMPOSITIONS”. All of the foregoing patents and patent applications cited in this paragraph are incorporated by reference herein in their entirety.

The ability to generate sequences of symbols that conform to some underlying stochastic process has many applications. Until now, symbol sequence generators have been implemented using conventional (so-called “classical”) computers. By “classical” it is meant that the computer operates in accordance with the laws of classical physics. However, there is now a new type of computer, called a quantum computer, that operates in accordance with a very different set of laws, namely, quantum physics. In accordance with the present systems, devices, and methods, the use of quantum computers allows the generation of symbol sequences, such as sequences of musical notes, and families of related symbol sequences, such as multiple tracks of related (harmonized) musical notes, in new and useful ways. For example, quantum superposition allows a quantum symbol sequence generator to create a multiplicity of realizations of some underlying stochastic process, in parallel, simultaneously. Although quantum physics prevents observation of all components of such a superposition, we can, nevertheless, determine collective properties of exponentially large numbers of realizations of the underlying stochastic process that would be quite infeasible to obtain classically. In addition, the final quantum state output from the quantum computer may be entangled, meaning that the various symbol sequences held in superposition are somewhat interdependent in the sense that measuring one can affect the measurements one will obtain on another. In accordance with the present systems, devices, and methods, the exploitation of such entanglement may be used to generate families of related realizations of some stochastic process that are not easy to obtain using conventional (classical) methods for complex stochastic processes.

The various embodiments described herein provide systems, devices, and methods for quantum computer-based symbol sequence generation. This capability is applied to generating symbol sequences representing musical events such as, but not limited to, the musical notes, musical chords, musical percussion strikes, musical time intervals, musical note intervals, and musical key changes that comprise a single track within a musical composition. The various embodiments described herein further include systems, devices, and methods for quantum-computer-based generation of families of symbol sequences. These are similarly applied to generating a family of symbol sequences representing musical events such as a set of music tracks, each a symbol sequence of musical events such as, but not limited to, the musical notes, musical chords, musical percussion strikes, musical time intervals, musical note intervals, and musical key changes, that comprise the multiplicity of tracks within a musical composition.

Quantum computers are machines harnessing quantum physical effects that allow them, in some cases, to perform computational tasks dramatically more efficiently than is possible using conventional (i.e., “classical”) computers. More generally, quantum computers can be thought of as quantum information processing devices for representing, storing, and manipulating quantum information, i.e., information stored within the states of quantum mechanical systems. As such quantum computers can perform certain information processing tasks, such as teleporting information, that are impossible in “classical” devices that operate based solely on classical physics. In accordance with the present systems, devices, and methods, computation and information come together in methods for generating sequences of symbols. It turns out that sequences of symbols have different properties depending on whether the symbols are encoded in states of quantum systems.

It is generally known that any classical sequence comprises an ordered arrangement of unambiguously distinguishable symbols, some or all of which might be repeated. Furthermore, it is also generally known that such a classical sequence can be reduced to a sequence of classical binary digits (i.e., 0s or 1s) by applying some standard convention for mapping symbols to bit vectors of a certain fixed length in a consistent manner. Thus, any classical sequence is formally equivalent to some sequence of bits, i.e., to some bit vector. Classical information theory asserts, and experiments confirm, that any classical sequence will most assuredly exhibit the following properties:
a. It can be compressed to no more than the Shannon bound.
b. It does not change upon being read.
c. Reading a part of the sequence does not change the unread parts of the sequence.
d. It can be copied, exactly, deterministically, without foreknowledge of the symbols it contains.
e. In binary form, it can be “negated” trivially by flipping each bit value from which the sequence is built.
   However, properties of a quantum sequence may be different from those of a classical sequence. For example, none of the properties (a)-(e) above are necessarily true of quantum sequences, i.e., sequences, encoded in quantum states. Thus, any system, device, or method that encodes, generates, or manipulates classical sequences might be expected to have a quantum counterpart that encodes, generates, or manipulates quantum sequences, which might exhibit different behavior.

In accordance with the present systems, devices, and methods, the fundamental ideas of information theory may be re-assessed when storing information in quantum states as opposed to in classical states. The qubit is the quantum analog of a classical bit. Almost any 2-state quantum system, such as an electron's spin, or an ion's internal energy levels, may be used to encode a qubit. The two classical bit values may be represented as quantum states (eigenkets) labeled |0> and |1>. Whereas a classical bit must be either 0 or 1, a qubit can be an arbitrary superposition of |0> and |1> simultaneously, i.e., a state such as a |0>+b|1> with a and b complex numbers such that |a|\hat{ }2+|b|\hat{ }2=1. When reading (or “measuring”) a superposition state a |0>+b|1>, it is not known how to predict with absolute certainty the bit value that the measurement will obtain. Instead, the probability of finding the qubit to be 0 is generally known as |a|\hat{ }2 and that of finding it to be 1 as |b|\hat{ }2. Moreover, the act of making the measurement appears to project the qubit into state |0> or state |1> consistent with the measurement outcome.

Any nontrivial quantum computation requires a quantum memory register of n qubits, n>0. In some application, n need only be around 50 for a quantum computer to perform specialized computations that outstrip the capabilities of any classical rival. The state of n qubits lies in a 2\hat{ }n-dimensional space spanned by the vectors |00 . . . 0>, |00 . . . 1>, . . . , |11 . . . 1> where vector contains n qubit variables. If the bit value of all n qubits are measured, the possible states in which the complete memory register can be found correspond to the 2\hat{ }n classically allowed bit strings that n bits can represent—that is, “00 . . . 0,” “00 . . . 1,” . . . , or “11 . . . 1”. However, between measurements, the n qubits can exist in superposition of all the 2\hat{ }n classical states. Quantum computers thus have tremendous capacity to work on several different computations at once. But unfortunately, quantum mechanics is generally understood to forbid reading the answer to each of these superposed computations individually. A measurement that reveals a collective property of all the answers may be made, which is often good enough to perform useful computation.

Quantum memory registers can exhibit quintessentially quantum behaviors that have no classical analogs. For example, suppose a 2-qubit quantum memory register is in the state (|00>+|11>)/√2. Initially, neither qubit is in a definite state as each could be found to be 0 or 1 with equal probability. But when one of the qubits is measured, the bit value of the other (unmeasured) qubit becomes definite. Such a state is said to entangled, because rather than the register's state being composed of a definite state for each qubit it contains, measurements made on one set of qubits have a side effect on another set of unmeasured qubits. The correlations between the bit values or entangled qubits can be much greater than anything classical bits can achieve. It is these excess correlations that ultimately account for much of quantum computing's power.

The foregoing describes the representation of information that a quantum computer can manipulate, but of further relevance to the present systems, devices, and methods is how such information can actually be used to compute. To this end, the evolution of any quantum system, such the quantum state that is input to a quantum computer, evolves in accordance with a standard equation, namely the Schrodinger equation. The solution of this equation shows that, for an isolated quantum system, if the initial state of the quantum circuit is |φᵢₙ>, then the output state will be given by |φₒᵤₜ>=U|φᵢₙ>, where U is some unitary operator, traditionally represented by a unitary matrix, i.e., one whose inverse equals its conjugate transpose (sometimes also referred to as its “adjoint”). Just as any classical computation can be decomposed into a sequence of classical logic gates (such as a sequence of NAND gates) that act on only a handful of classical bits at a time, so too can any quantum computation, represented by a unitary matrix such as U, be broken down into a sequence of quantum logic gates that act on only a handful of qubits at a time. A difference is that whereas classical logic gates are restricted to operate on input values that correspond to some sequence in which each bit is wholly 0 or wholly 1, quantum gates and quantum circuits built from quantum gates can operate on input values that are superpositions of bit vectors encoded in eigenkets (such as |000>, |001>, . . . , |111> etc), and more generally even mixed states of bit vectors encoded in eigenkets.

In various implementations of the present systems, devices, and methods, the aforementioned features of quantum computing are used to build quantum circuits that can generate sequences of symbols, such as musical events (e.g., music notes, chords, percussion events, rests, and similar). Certain specific exemplary implementations are described.

As previously described, a quantum computer may accept a first quantum state as input, transform it into, for example, a second quantum state, and this second quantum state may be measured (or “read”) to yield a classical output, namely, an “answer” to the quantum computation.

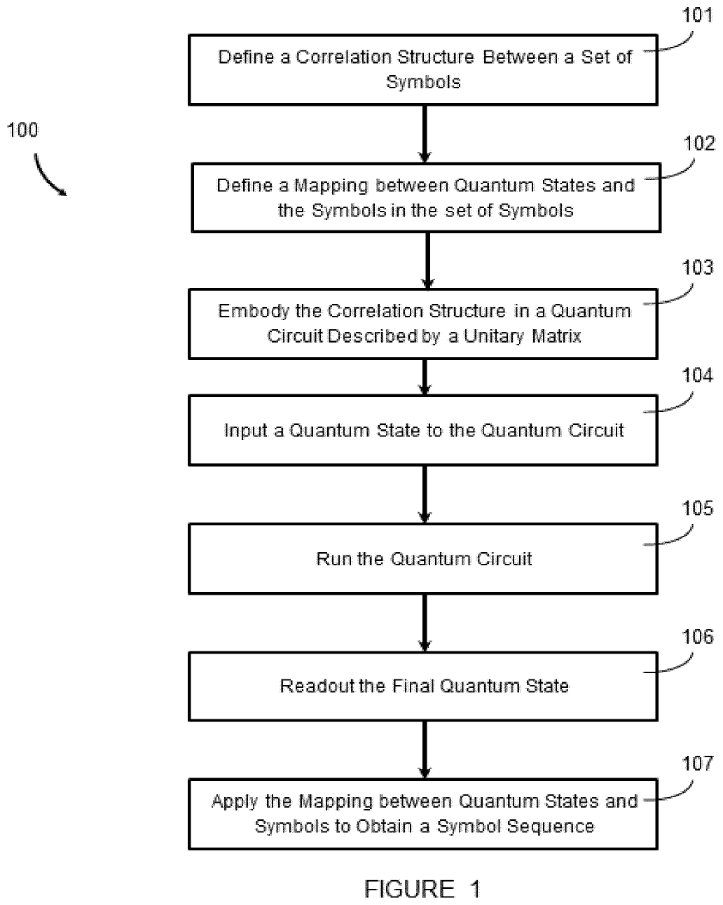

FIG. 1 is a flow diagram showing an exemplary method 100 for generating symbol sequences using a quantum computer in accordance with the present systems, devices, and methods. Method 100 includes seven acts 101, 102, 103, 104, 105, 106, and 107, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 101, a data object is defined, e.g., by a computer system such as a quantum computer system or a classical computer system in communication with a quantum computer system. The data object may describe a desired correlation structure between a set of symbols.

The data object may be defined by a user or learned via some training procedure.

At 102, a mapping between quantum states and the symbols described in the data object is defined, e.g., by a computer system such as a quantum computer system or a classical computer system in communication with a quantum computer system. For example, in an implementation of method 100 in which symbol sequences are generated over an alphabet of eight symbols, A, B, C, D, E, F, G, and H, mapping 102 may be accomplished by associating each 3-qubit computational basis eigenket, |000>, |001>, |010>, |011>, |100>, |101>, |110>, |111>, with a unique symbol as follows: A=|000>, B=|001>, C=|010>, D=|011>, E=|100>, F=|101>, G=|110>, and H=|111>, and a corresponding inverse mapping (which may be needed to interpret an output sequence of bits as a symbol sequence at act 107 described later on) would be |000>=A, |001>=B, |010>=C, |011>=D, |100>=E, |101>=F, |110>=G, and |111>=H. In general, basis eigenkets of length k may be used to index up to 2\hat{ }k symbols unambiguously, i.e., in a manner such that the mapping is 1-to-1 and invertible. In such a case each unique symbol would have a basis eigenket code containing k qubits that is unique to that symbol.

According to the present systems, device, and methods, the mapping at 102 may relate quantum states to symbols representing musical events such as, but not limited to, musical notes (e.g., “C”, “C♯”, “Db”, “D”, “D♯”, “Eb”, “E”, F “F♯”, “Gb”, “G”, “G♯”, “Ab”, “A”, “A♯”, “Bb”, “B”, or “octaved” versions thereof, e.g., “Dl”, “C2”, “Ab3”, “D♯4”, “F5”, “B6”, wherein the integers denote octaves, etc.), musical chords (e.g., “Aminb5”, “Csus”, etc.), musical keys (e.g., “AbMajor”, “ENaturalMinor”, “D♯Japanese”, “GbEnigmatic”), musical percussion events (e.g., “BassDrum”, “Snare”, “Bongo”, etc.), musical timings (e.g., absolute times such as “Beat3Bar7”, “Beat1 Bar11”, or durations such as “QuarterNote”, “HalfNote”, “EightNote” etc.), musical instruments (e.g., “Piano”, “ElectricGuitar”, etc.), musical components (e.g., “Intro”, “Verse”, “PreChorus”, “Chorus”, “Bridge”, “Outro”, “Bar5”, “Track2”, “Motif3”, “Hook4”. “Verse5”, etc.), and/or musical operations, (e.g., “Notelnversion”, “NoteReversal”, etc.).

At 103, the desired correlation structure defined is 101 is embodied in a quantum circuit. In other words, a quantum circuit that embodies the correlation structure is designed, developed, or generally defined.

At 104, an initial quantum state is input to the quantum computer, the initial quantum state conforming to an initial symbol from the set of symbols for which the desired correlation structure is defined at 101.

At 105, the quantum circuit is executed or “run” on the initial quantum state from 104 to produce an output state.

At 106, the respective states of the qubits of the quantum computer are measured or “read out” to characterize the output state produced at 105.

At 107, the mapping between quantum states and symbols defined at 102 is applied to map the measured qubit states from 106 to a sequence of symbols, which is the symbol sequence generated by method 100.

A person of skill in the art will appreciate that the quantum computer may be interfaced to auxiliary computers and communications equipment so that inputs can be sent to and outputs received from the quantum computer. Furthermore, such auxiliary computers might be local to the quantum computer or might be made available as a cloud computing resource.

In some implementations of the present systems, devices, and methods, a symbol sequence may be generated by sampling from a quantum state encoding a probability distribution induced by a unitary matrix. For example: the data object defined at 101 may take the form of a 2\hat{ }n×2\hat{ }n dimensional unitary matrix that is implemented as an n-qubit quantum circuit; the mapping between quantum states and symbols defined at 102 may take the form of a correspondence between the 2\hat{ }k possible k-qubit computational basis eigenkets and (up to) 2\hat{ }k symbols; the initial quantum state input at 104 may take the form of a pure quantum state corresponding to the tensor product of the eigenket for a chosen initial symbol with eigenkets |0> for the remaining input qubits; and the quantum circuit designed, developed, or generally defined at 103 may transform the initial quantum state from act 104 deterministically under the action of the unitary matrix data object from act 101 to yield a corresponding output quantum state, |psi>, which is a superposition of all possible and only symbol sequences that are reachable from the initial symbol under the action of the unitary matrix. The deterministically constructed output superposition quantum state, |psi>, may be measured at 106 by reading each of its component qubits in the computational basis to obtain an output sequence of qubits each in the computational basis. The output sequence of qubits may be partitioned into consecutive runs of k qubits and interpreted as a symbol sequence at 107 by applying the mapping 102 between quantum states and symbols.

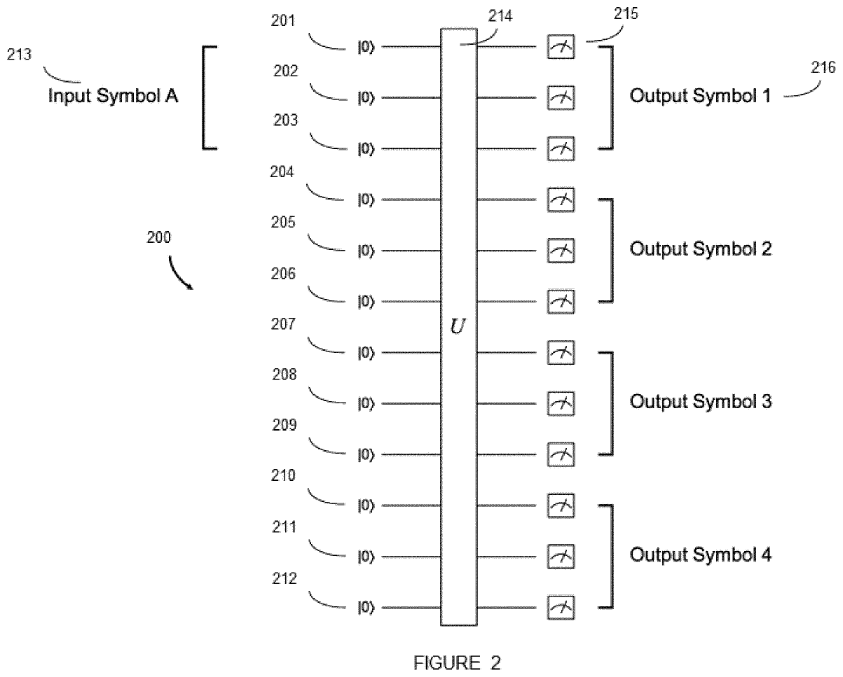

A more detailed example of the foregoing implementation is depicted in FIG. 2. FIG. 2 is an illustrative diagram showing an exemplary quantum circuit 200, together with a set of inputs 201-212 and measurement operations on outputs, that is capable of generating symbol sequences (e.g., sequences of musical events) in accordance with the present systems, devices, and methods. By regarding symbols as synonymous with sequences of k qubits, such as the group [201, 202, 203] in FIG. 2, an n-qubit quantum computation having n=m k (for integers m>0, k>0) over qubits 201-212 may be interpreted as accepting, as input, a single symbol 213, e.g., IA>=1000>, and generating, after measurement on the output, a sequence of m symbols that can follow sequentially from the said initial symbol to form the output symbol sequence. In the exemplary case of quantum circuit 200, n=12 qubits (201 through 212) are grouped into m=4 symbols, each comprising k=3 qubits ([201, 202, 203], [204, 205, 206], [207, 208, 209] and [210, 211, 212]), with input state 213 corresponding to the quantum state |A>=|000>. Thus, the net input to the quantum circuit 200 is the tensor product of |A> with a notional standard input for the remaining qubits such as, in this exemplary case, |000000000>, making the overall input |A>⊗|000000000>=|000>⊗|000000000>=|000000000000>. In this example, the matrix 214 is defined by a unitary matrix, U, i.e., a matrix whose matrix inverse equals its matrix adjoint or, equivalently, its conjugate transpose. The output quantum state, |psi>=U |A>|000000000>=U |000>|000000000>=U |000000000000>, generated by the action of the unitary matrix 214 on the input quantum state is a pure state superposition of all and only the possible symbol sequences that are reachable starting from the given initial state, in the exemplary case |A>|000000000>. The actual symbol sequence output may be one of the eigenkets contained within the aforementioned output superposition, with the particular one determined by performing a measurement in the computational basis (depicted by the icons 215) on each output qubit of the state, |psi>. Furthermore, in the example of FIG. 2, the unitary matrix U is decomposed into a quantum circuit comprising a sequence of few-qubit quantum gates at least one of which contains adjustable free parameters. These free parameters may be “trained” through a learning procedure to values that permit the circuit to generate symbol sequences of the sort desired.

In some implementations of the present systems, devices, and methods, a symbol sequence may be generated by sampling from a conditionally constructed quantum state encoding a probability distribution induced by an arbitrary matrix. For example, the data object defined at 101 may take the form of an arbitrary (i.e., not necessarily unitary) 2\hat{ }n×2\hat{ }n dimensional matrix, N, which is implemented within a 2\hat{ }(n+1)×2\hat{ }(n+1) dimensional unitary matrix, M, given mathematically by:

$$M = exp ( - i ɛ ( \begin{matrix}0 & - iN \\ {iN}^{†} & 0\end{matrix} ) )$$

where i is the complex number equal to the square root of −1, i.e., i=sqrt(−1), s is a small positive real number 0<ε<1, exp(.) is the matrix exponential function, N superscript dagger, N^{†}, is the conjugate transpose of the matrix N (equivalently the matrix adjoint of N), 0 is a matrix of all zeroes, N is the arbitrary matrix specifying the desired correlation structure mentioned above (i.e., the data object), and the matrix

$$( \begin{matrix}0 & - iN \\ {iN}^{†} & 0\end{matrix} )$$

is a block matrix. The unitary operator given by M may be implemented as a (n+1)-qubit quantum circuit. In this example: the mapping between quantum states and symbols defined at 102 may take the form of a correspondence between the 2\hat{ }k possible k-qubit computational basis eigenkets and (up to) 2\hat{ }k symbols; the initial quantum state input at 104 may take the form of a pure quantum state corresponding to the tensor product of the 10> eigenket, the eigenket for a chosen initial symbol, and the eigenkets 10> for the remaining (n-k) input qubits; and the quantum circuit designed, developed or generally defined at 103 may transform the input quantum state deterministically under the action of the unitary matrix M built from the data object defined at 101 (which is an arbitrary 2\hat{ }n×2\hat{ }n dimensional matrix in this exemplary implementation) to yield a corresponding output quantum state, |psi>, which is an (n+1)-qubit superposition state.

Continuing this example, if the first qubit in the output (n+1)-qubit superposition state, |psi>, is measured and found to be |1>, this may be deemed a “success” and the remaining qubits of |psi> will contain a good approximation to the desired correlation structure specified by the arbitrary matrix N. Conversely, if the first qubit in the output (n+1)-qubit superposition state, |psi>, is measured and found to be |0>, the this may be deemed a “failure” and the remaining qubits of |psi> will be in some new state |phi>, and the whole computation may be repeated starting on the new input state, the tensor product of |0> and |phi>, i.e., |0>|phi> or, alternatively, restarting completely using the state |0>|1stSymbol>|0 . . . 0>, where |1stSymbol> is the eigenket corresponding to the starting symbol. The computation may be repeated until the first qubit is measured to be in the |1> state and the deterministically constructed output superposition quantum state, |psi>, may be measured by reading each of its component qubits in the computational basis to obtain an output sequence of qubits each in the computational basis, which may be partitioned into consecutive runs of k qubits and thereby interpreted as a symbol sequence by inverting the applying mapping between quantum states and symbols from 102.

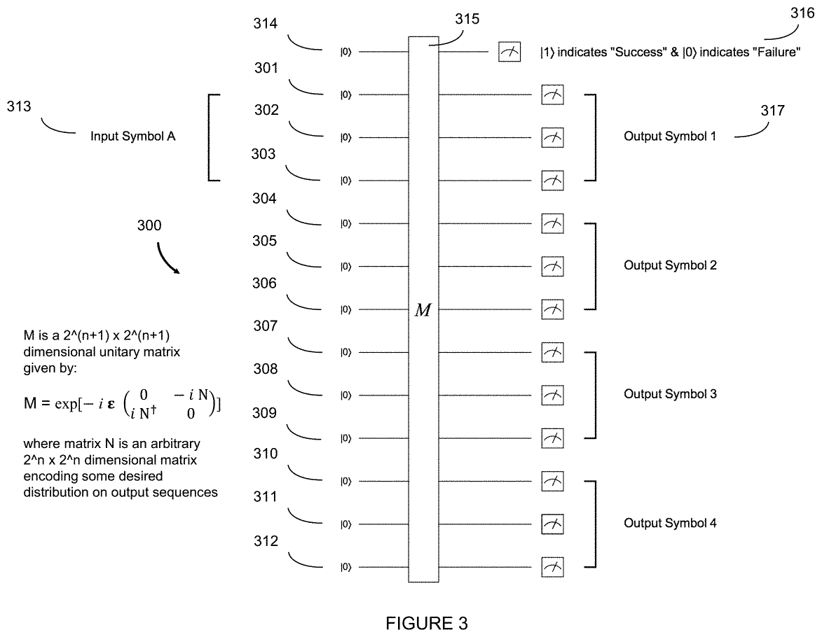

A more detailed example of the foregoing implementation is depicted in FIG. 3. FIG. 3 is an illustrative diagram showing an exemplary quantum circuit 300 derived from an underlying arbitrary matrix, together with a set of inputs 301-312, and measurement operations on outputs 316 and 317 (collectively), that is capable of generating symbol sequences conditional on the result obtained by measuring a single qubit 316, or a subset of qubits in accordance with the present systems, devices, and methods. By regarding symbols as synonymous with sequences of k qubits, such as the group, [301, 302, 303], any n-qubit quantum computation, having n=m k (for integers m>0, k>0), over qubits 301-312, may be interpreted as accepting, as input, a single symbol 313, e.g., |A>=|000>, and generating, after measurement on the output, a sequence of m symbols, that can follow sequentially from the initial symbol to form the output symbol sequence. In the exemplary case, n=12 qubits (301-312) are grouped into m=4 symbols, each comprising k=3 qubits ([301, 302, 303], [304, 305, 306], [307, 308, 309] and [310, 311, 312]), with input state 313 corresponding to the quantum state |A>=|000>. Thus, the net input to the quantum circuit 300 is the tensor product (⊗) of |0>, |A>, and a notional standard input for the remaining qubits such as, in an exemplary case, |000000000>, making the overall input |0>⊗|A>⊗|000000000>=|0>⊗|000>⊗|000000000>=|000000000000>. In this implementation, the matrix 315 is defined by a unitary matrix, M, i.e., a matrix whose matrix inverse equals its matrix adjoint or, equivalently, its conjugate transpose given as the matrix exponential of a block matrix involving the arbitrary matrix, N. The output quantum state, |psi>=M |0>|A>|000000000>=M |0>|000>|000000000>=M |0000000000000>, generated by the action of the unitary matrix 315 on the input quantum state may be a pure state superposition. If a first qubit is measured (316) and found to be in the |1> state, then the computation may be deemed a “success” and the remaining qubits in the output will contain the correlation structure implicit in the arbitrary matrix N (e.g., the remaining n-qubits will experience a transformation that is approximately given by N acting on the initial state |A>|000000000>, i.e., N |A>|000000000> in the exemplary case of FIG. 3). If the first qubit is measured (316) and found to be in the 10> state, then the computation may be deemed a “failure” and the remaining qubits in the output will be the state |phi> which is close to their initial state. The computation may therefore be repeated using either the starting state 10>|phi>, or the starting |0>|A>|000000000> in the exemplary case.

Once a first qubit is found to be in the |1> state, each remaining qubit may be measured in the output state. The actual symbol sequence output may be one of the eigenkets contained within the aforementioned output superposition, |psi> but conditioned on the first qubit being |1>. The specific eigenket may be determined by performing a measurement in the computational basis (depicted by the “meter” icons in FIG. 3) on each output qubit of the state |psi> conditioned on its first qubit being |1>. Furthermore, in this implementation, the unitary matrix M is decomposed into a quantum circuit comprising a sequence of few-qubit quantum gates at least one of which contains adjustable free parameters. These free parameters may be “trained” through a learning procedure to values that permit the circuit to generate symbol sequences of the sort desired.

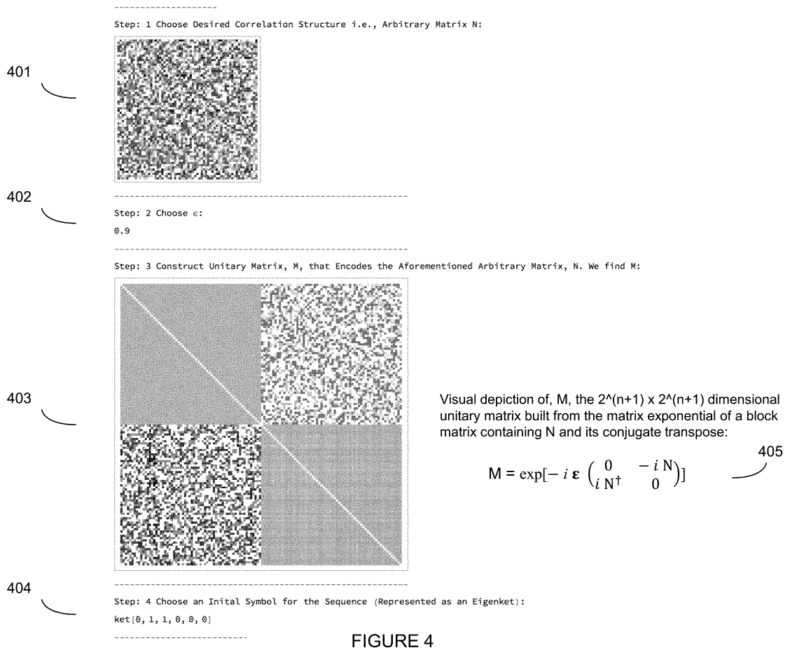

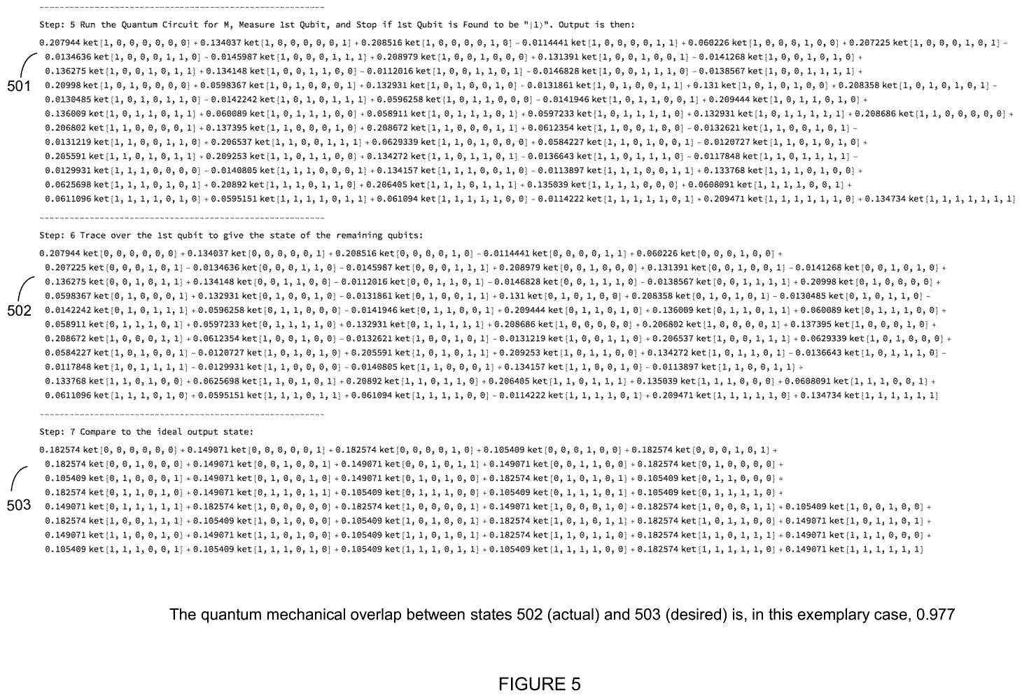

FIG. 4 and FIG. 5 collectively show an illustrative example of a realization of the process described in FIG. 3, in accordance with the present systems, methods, and devices. Specifically, FIG. 4 and FIG. 5 together show a worked example for the case of a 3-step process (initial symbol then joined to two output symbols) that is initialized in symbol |011>=|D> using the encoding A=|000>, B=|001>, C=|010>, D=|011>, E=||00>, F=|101>, G=|110>, and H=|111>. FIG. 4 shows the selection, at 401, of an arbitrary 2\hat{ }×2\hat{ }n dimensional matrix N to represent the desired correlation structure, illustrated as an array of grayed pixels in which each pixel represents a matrix element, whose value is indicated by a particular shade of gray. Gray pixels are used as representations of matrix elements in FIG. 4 because, in the exemplary case, the matrix is for dimension 2\hat{ }6×2\hat{ }6=64×64, which is rather large to illustrate explicitly. FIG. 4 also shows, at 402, the selection of a parameter value for epsilon of 0.9 in the exemplary case, and at 403 the use of the arbitrary matrix N within the construction of the unitary matrix M as defined by 405. FIG. 4 also shows, at 404, the selection of a starting symbol, D=|011> in the exemplary case.

FIG. 5 continues the same example from FIG. 4, showing at 501 the state of the output (n+1) qubits in the circumstances of “success”, equivalent to finding the first qubit in state |1>. Conditioned on such “success”, FIG. 5 shows the resulting quantum state of the remaining n qubits at 502 (obtained by tracing over the first qubit that was found to be |1>). At 503, FIG. 5 shows a comparison between the obtained output state at 502 and the hypothetically ideal quantum state, i.e., N |D>|000>. As illustrated, the two exemplary states are fairly close as can be verified from their quantum mechanical overlap, which in the exemplary case is 0.977 (on a scale where 0 means a totally orthogonal state, and 1 means exactly the same state). Thus, conditioned on the first qubit of the output being found to be in the |1> the remaining qubits will be in the state that is approximately N |D>|000> in this exemplary case. Interpreting these last 3 qubits as |A>, this gives an overall sequence of |D>|A> as the output sequence.

In some implementations of the present systems, devices, and methods, a symbol sequence may be generated by sampling from a quantum state encoding all possible symbol sequences reachable from an initial state via a stochastic process. For example, the mapping between quantum states and symbols defined at 102 may include a correspondence between the 2\hat{ }k possible k-qubit computational basis eigenkets and (up to) 2\hat{ }k symbols and the data object defined at 101 to describe a desired correlation structure between a set of symbols may include a 2\hat{ }n×2\hat{ }n dimensional specially-structured unitary matrix implemented, in this example, as an n-qubit quantum circuit that repeats a particular sequence of controlled quantum gates in a staggered cascading fashion along the sequence of input qubits in offsets of k qubits (i.e., one symbol) at a time. The initial quantum state input at 104 may, in this example, include a pure quantum state corresponding to the tensor product of the eigenket for a chosen initial symbol with eigenkets |0> for the remaining input qubits, or, depending on the implementation, a pure quantum state corresponding to the tensor product of a superposition of eigenkets for a chosen set of initial symbols (submitted in parallel) with eigenkets |0> for the remaining input qubits, or, depending on the implementation, a mixed quantum state corresponding to the tensor product of a mixed state for a chosen set of initial symbols (in parallel) with eigenkets |0> for the remaining input qubits. The quantum circuit designed, developed, or generally defined at 103 may, in this example, transform the input quantum state deterministically under the action of the data object defined at 101 (i.e., a structured unitary matrix in this implementation) to yield a corresponding output quantum state, |psi>, which is a superposition of all possible and only symbol sequences that are reachable from the initial quantum state under the action of the structured unitary matrix. The deterministically constructed output superposition quantum state, |psi>, may be measured by reading each of its component qubits in the computational basis to obtain an output sequence of qubits each in the computational basis, which may be partitioned into consecutive runs of k qubits and thereby interpreted as a symbol sequence by applying the mapping between quantum states and symbols defined at 102.

Continuing the example above, in some implementations the repeating sequence of controlled quantum gates, arranged in a staggered and cascading fashion along the sequence of input qubits in offsets of k qubits at a time, may be derived from an associated probability transition matrix, P, of a stochastic process over a set of 2\hat{ }k distinct symbols, by defining P as a probability transition matrix over a set of 2\hat{ }k symbols, i.e., a 2\hat{ }k×2\hat{ }k dimensional matrix of the form:

$$P = ( \begin{matrix}{p}_{0 , 0} & {p}_{0 , 1} & ⋯ & {p}_{0 , {2}^{k} - 1} \\ {p}_{1 , 0} & {p}_{1 , 1} & ⋯ & {p}_{1 , {2}^{k} - 1} \\ ⋮ & ⋮ & ⋱ & ⋮ \\ {p}_{{2}^{k} - 1 , 0} & {p}_{{2}^{k} - 1 , 2} & ⋯ & {p}_{{2}^{k} - 1 , {2}^{k} - 1}\end{matrix} )$$

where the matrix elements, {Pᵢⱼ}, each non-negative and less than or equal to 1, give the probability with which the symbol represented by index j will follow the symbol represented by index i in any realization of the stochastic process, and where the rows each sum to unity. In general, such a probability transition matrix P may not be a unitary matrix and may not therefore be encoded directly as a quantum gate. However, a larger unitary matrix that imposes the state to state (symbol to symbol) transition probabilities contained within P may be constructed, for example, according to the following procedure:
a. Define each row of P as a separate matrix, P0 to P2\hat{ }k−1, whose leftmost columns are the square roots of the consecutive row values and whose remaining entries are all zeroes, i.e.,

$${P}_{1} = ( \begin{matrix}\sqrt{{p}_{0 , 0}} & 0 & ⋯ & 0 \\ \sqrt{{p}_{1 , 0}} & 0 & ⋯ & 0 \\ ⋮ & ⋮ & ⋱ & ⋮ \\ \sqrt{{p}_{{2}^{k} - 1 , 0}} & 0 & ⋯ & 0\end{matrix} ) , {P}_{2} = ( \begin{matrix}\sqrt{{p}_{0 , 0}} & 0 & ⋯ & 0 \\ \sqrt{{p}_{1 , 0}} & 0 & ⋯ & 0 \\ ⋮ & ⋮ & ⋱ & ⋮ \\ \sqrt{{p}_{{2}^{k} - 1 , 1}} & 0 & ⋯ & 0\end{matrix} ) , … , \\ … {P}_{{2}^{k}} = ( \begin{matrix}\sqrt{{p}_{0 , {2}^{k} - 1}} & 0 & ⋯ & 0 \\ \sqrt{{p}_{1 , {2}^{k} - 1}} & 0 & ⋯ & 0 \\ ⋮ & ⋮ & ⋱ & ⋮ \\ \sqrt{{p}_{{2}^{k} - 1 , {2}^{k} - 1}} & 0 & ⋯ & 0\end{matrix} )$$

b. Compute the singular value decomposition of each such matrix, Pi, to yield a decomposition of the form Pᵢ=uᵢ.wᵢ. Conjugate[Transpose[vᵢ]], for matrices uᵢ, wᵢ, and vᵢ.
c. For each matrix Pi, define a new matrix Ui (which is unitary) as the dot product: Uᵢ=uᵢ. Conjugate[Transpose[vᵢ]] (which is lacking the wᵢ matrix).
d. Form the 2\hat{ }(2k)×2\hat{ }(2k) dimensional direct sum of all the unitary matrices Ui, namely:

$$U = {U}_{0} ⊕ {U}_{0} ⊕ ⋯ ⊕ {U}_{{2}^{k} - 1} = ( \begin{matrix}{U}_{0} & 0 & ⋯ & 0 \\ 0 & {U}_{1} & ⋯ & 0 \\ ⋮ & ⋮ & ⋱ & ⋮ \\ 0 & 0 & ⋯ & {U}_{{2}^{k} - 1}\end{matrix} )$$

to yield a unitary matrix (i.e., a matrix whose matrix inverse equals its matrix adjoint or, equivalently, its conjugate transpose) that will enforce the symbol to symbol transitions of the probability transition matrix, P.

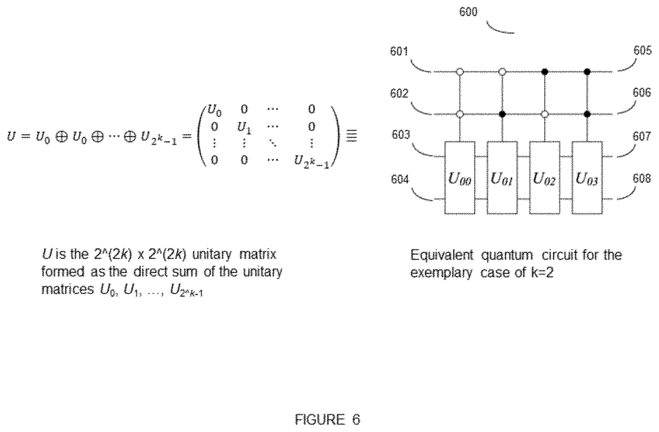

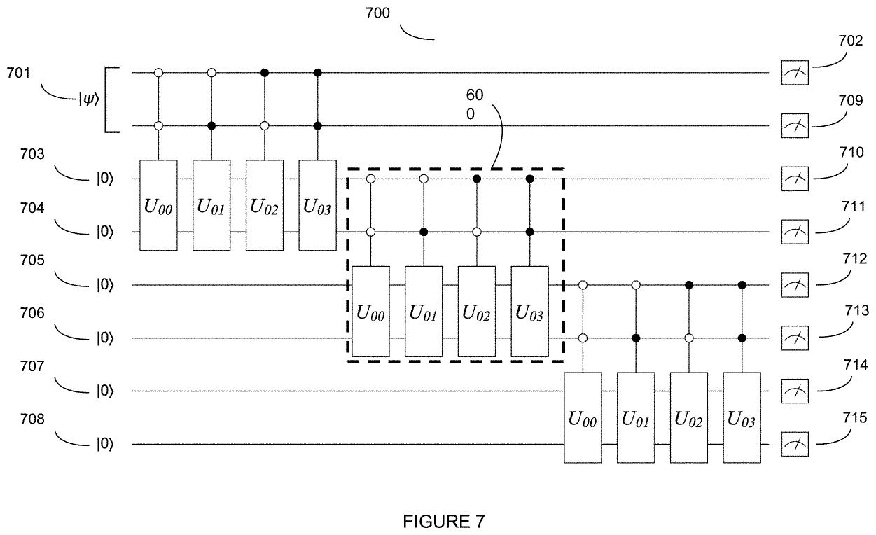

As illustrated in FIG. 6, the direct sum matrix U may, in this example, include a 2\hat{ }(2k)×2\hat{ }(2k) dimensional unitary matrix, equivalent to a 2k-qubit quantum circuit, called the “Controlled-U gate” 600, whose qubits can be pictured as grouped into a first set of k “control” qubits [601, 602] and a subsequent set of k “target” qubits [603, 604]. The unitary matrix U will apply unitary operator Uᵢ to the k target qubits whenever the k control qubits contain the binary code for the integer i. After the operation of the quantum circuit for U, the k control qubits [605, 606] are not acted upon further, and the k target qubits [607, 608] become the k control qubits of the next Controlled-U gate as can be seen in FIG. 7. The net effect is that the application of the quantum circuit 700 (which comprises multiple applications of the “Controlled-U gate” 600 on consecutive groups of 2k qubits, each application offset by k qubits from the preceding Controlled-U gate) will cause the final output quantum state to become a superposition of all and only the symbol sequences reachable from starting state 701 under the action of the circuit 700. Note that the starting state 701 can be either a single symbol or, more efficiently, a superposition of states reachable from a desired starting state by applying unitary operator Ui to starting state |i>. This has the effect of feeding the quantum circuit 700 with a superposition of control values at the first application of the “Controlled-U gate” 600. Either way, thereafter, reading out the value of each qubit in the output (indicated by the meters [702, and 709 to 715]) will generate a sample from this output superposition state.

More details of an exemplary case are depicted in FIG. 7. By regarding symbols as synonymous with sequences of k qubits (k=2 in this exemplary case), such as the pairs [703, 704], [705, 706], and [707, 708], any n-qubit quantum computation, having n=m k (for integers m>0, k>0), over qubits 701 to 708, may be interpreted as accepting, as input, a single symbol 701, e.g., any of the symbols |A>=|00>, |B>=|01>, |C>=|10>, or |D>=|11> in this exemplary case, and generating, after measurement on the output, a sequence of m symbols, that can follow sequentially from the initial symbol 701 to form the output symbol sequence. In the exemplary case, n=8 qubits (701 through 708) are grouped into m=4 symbols, each comprising k=2 qubits (the pair 701, and the subsequent qubit pairs [703, 704], [705, 706], [707, 708], with input quantum state |φ>, which can be any of the symbols |A>, |B>, |C>, or |D>, or a superposition thereof created by applying the appropriate Ui operator acting on input |i> (where integer i is written in binary). Thus, the net input to the quantum circuit 700 is the tensor product of |φ> with a notional standard input for the remaining qubits such as, in the exemplary case, |φ>|000000>. For example, to initialize the sequence in state |B>=|01>, the state |φ>=U01|01> (which is a superposition of the symbols that can follow from symbol B according to the process defined by a probability transition matrix P) may be input. The overall input would then be |φ>⊗|000000>=(U01|01>)⊗|000000>. The output quantum state may then be given by the action of the unitary matrix embodied in the quantum circuit 700 applied to this input state. The overall quantum circuit is built by applying the Controlled-U gate 600 to consecutive groups of 2k qubits, each offset by k qubits from the last application. Therefore, the unitary matrix corresponding to the exemplary quantum circuit 700 is:

( [symbol] ⊗ [symbol] ⊗ [symbol] ⊗ [symbol] ⊗U)·( [symbol] ⊗ [symbol] ⊗U⊗ [symbol] ⊗ [symbol] )·(U⊗ [symbol] ⊗ [symbol] ⊗ [symbol] ⊗ [symbol] )|φ [symbol] |000000

[symbol]

where [symbol] is the 2×2 identity matrix, corresponding to “no-operation” on a qubit. Applying this unitary operator to the input with the initial symbol set to |φ>), the output may be computed as the quantum state, |ϕ [symbol] :

|ϕ [symbol] =( [symbol] ⊗ [symbol] ⊗ [symbol] ⊗ [symbol] ⊗U)·( [symbol] ⊗ [symbol] ⊗U⊗ [symbol] ⊗ [symbol] )·(U⊗ [symbol] ⊗ [symbol] ⊗ [symbol] ⊗ [symbol] )|φ [symbol] |000000

[symbol]

The actual symbol sequence output may then be one of the eigenkets contained within the above output superposition |ϕ [symbol] . The specific eigenket may be determined by performing a measurement in the computational basis (depicted by the meter icons [702 and 709-715]) on each output qubit of the state |ϕ [symbol] .

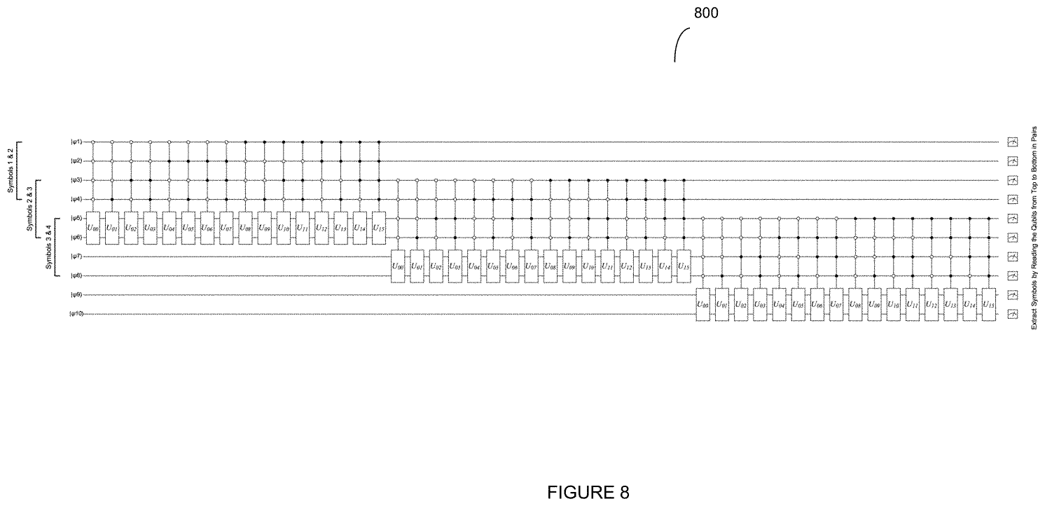

In some implementations, a probability transition matrix, P, may include a probability transition matrix between sub-sequences of symbols, rather than single symbols. Accordingly, the Controlled-U gate 600 may include a controlled quantum gate over multiple preceding symbols, rather than just the most recent preceding symbol. This is illustrated in FIG. 8, which shows an exemplary quantum circuit 800 for three steps of a stochastic process in which each successive symbol depends on the two immediately preceding symbols, each having one of 4 possible values (in the exemplary case).

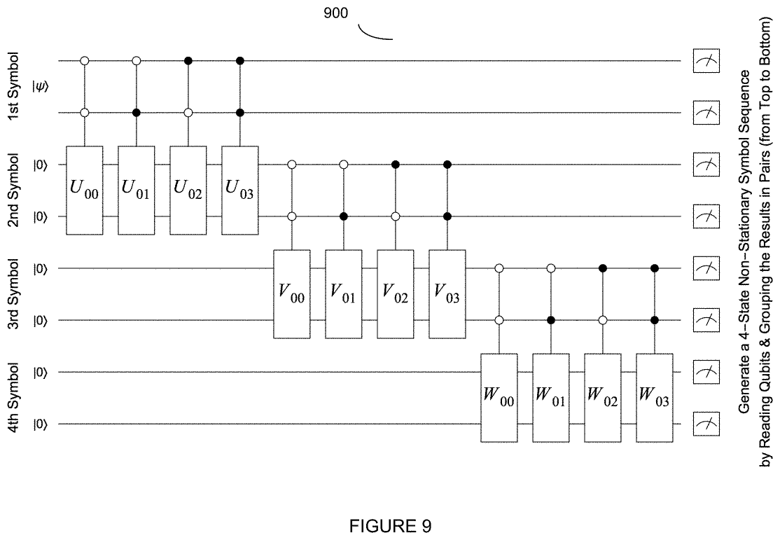

In some implementations, a probability transition matrix, P, may be replaced by a family of probability transition matrices representing a non-stationary stochastic process between single symbols, or sub-sequences of symbols. Accordingly, the Controlled-U gate 600 may include a controlled quantum gate that changes from step to step of the process. That is, the quantum sequence generator can be generalized to create symbol sequences from a non-stationary process. This is illustrated in FIG. 9, which shows a quantum circuit 900 for three steps of a stochastic process in which each “Controlled-U gate” is derived from a different probability transition matrix.

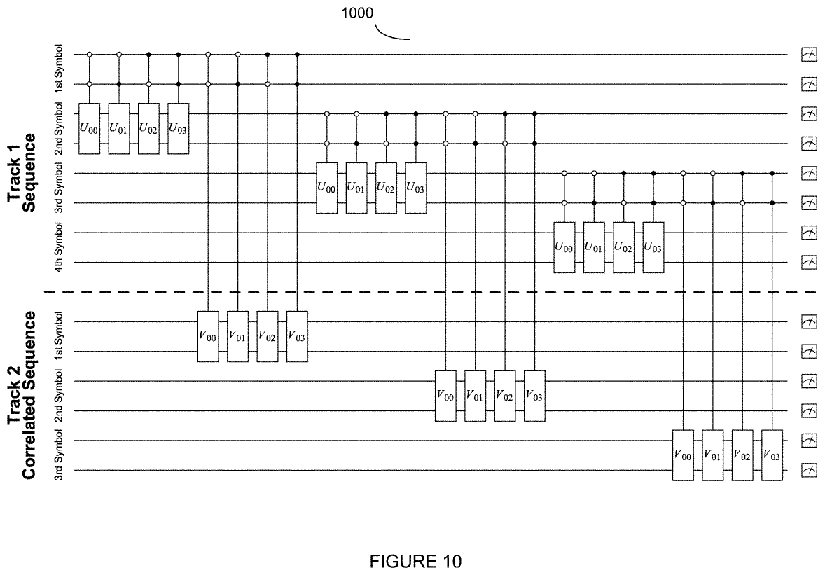

In some implementations, families of sequences of tunably correlated symbols may be generated by coupling the control qubits of one sequence to the target qubits of two or more sequences. FIG. 10 shows an exemplary case of a quantum circuit 1000 to generate a pair of tunably correlated symbol sequences in accordance with the present systems, devices, and methods. In particular, FIG. 10 shows a circuit that can generate three steps of a pair of tunably correlated stochastic processes, each over alphabets of the same or different 4 symbols. Even though, in this exemplary case, the control qubits are shared between sequence generator circuits, the probability transition matrices they drive (implemented as Controlled-U and Controlled-V gates in the respective sequence generator circuits) need not be, but could be, the same. Such a circuit may generate pairs of sequences with a controllable degree of correlation between them.

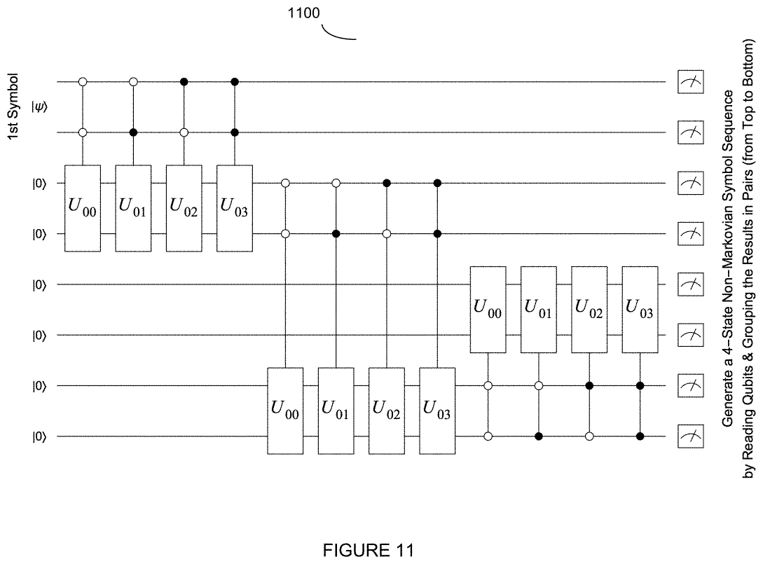

In some implementations, symbol sequences may be generated whose symbol dependencies are not determined sequentially along the sequence, i.e., symbol sequences containing past and future dependencies. For example, by embedding the Controlled-U gates in various non-standard ways, symbol sequence generators may be created in which the probability of a next symbol is dependent not only on some or all preceding symbols but also on some or all subsequent symbols. FIG. 11 shows an exemplary case in which the quantum circuit for the symbol sequence generator 1100 is configured so that the second symbol depends on the first symbol, the fourth symbol depends on the second symbol and the third symbol depends on the fourth symbol.

In the various implementations described herein, references to “quantum states”, “pure states”, or “superpositions” also allow for the possibility of having “mixed” states.

In the various implementations described herein, references to “unitary matrices” or “unitary operators” also allow for the use of “super-operators or completely positive maps” alone, or in conjunction with one or more “ancilla qubits”, i.e., auxiliary qubits that assist in achieving some desired quantum computation.

In the various implementations described herein, references to “qubits”, “quantum bits”, “superpositions”, and “mixed states” also allow for the possibility of using “qudits”, i.e., d-state quantum systems (whereas qubits are 2-state quantum systems). Likewise, references to “quantum gates”, “quantum circuits”, and “Controlled-U gates”, “Controlled-V gates”, also allow for the possibility of using quantum gates, quantum circuits, and measurements that act upon qudits.

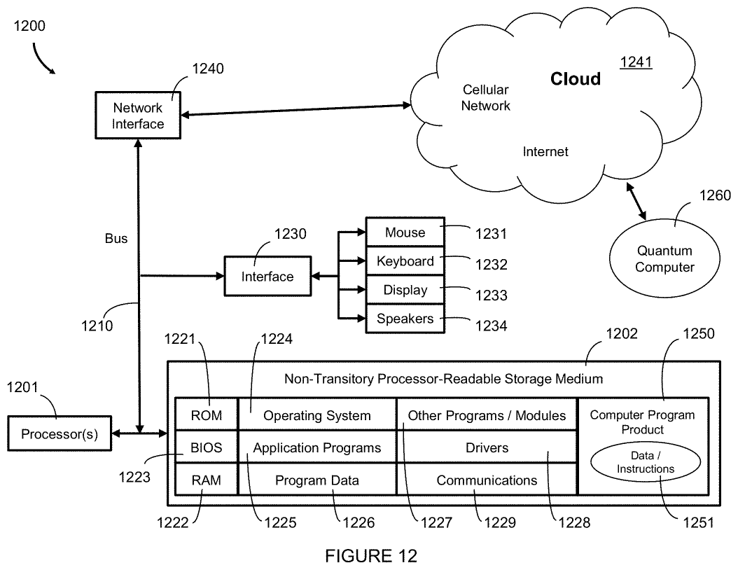

The various implementations described herein often make reference to “computer-based,” “computer-implemented,” “at least one processor,” “a non-transitory processor-readable storage medium,” “quantum computer,” and similar computer-oriented terms. A person of skill in the art will appreciate that the present systems, devices, and methods may be implemented using or in association with a wide range of different hardware configurations, including localized hardware configurations (e.g., a desktop computer, laptop, quantum computer, smartphone, or similar) and/or distributed hardware configurations that employ hardware resources located remotely relative to one another and communicatively coupled through a network, such as a cellular network or the internet. For the purpose of illustration, exemplary computer systems suitable for implementing the present systems, devices, and methods are provided in FIG. 12.

FIG. 12 is an illustrative diagram of an exemplary computer-based symbol sequence generation system 1200 suitable at a high level for performing the various computer-implemented methods described in the present systems, devices, and methods. Although not required, some portion of the implementations are described herein in the general context of data, processor-executable instructions or logic, such as program application modules, objects, or macros executed by one or more processors. Those skilled in the art will appreciate that the described implementations, as well as other implementations, can be practiced with various processor-based system configurations, including handheld devices, such as smartphones and tablet computers, multiprocessor systems, microprocessor-based or programmable consumer electronics, personal computers (“PCs”), network PCs, minicomputers, mainframe computers, quantum computers, and the like.

Computer-based symbol sequence generation system 1200 includes at least one processor 1201 (i.e., a “classical” or“digital” computer processor), a non-transitory processor-readable storage medium or “system memory” 1202, and a system bus 1210 that communicatively couples various system components including the system memory 1202 to the processor(s) 1201. Computer-based symbol sequence generation system 1200 is at times referred to in the singular herein, but this is not intended to limit the implementations to a single system, since in certain implementations there will be more than one system or other networked computing device(s) involved. Non-limiting examples of commercially available processors include, but are not limited to: Core microprocessors from Intel Corporation, U.S.A., PowerPC microprocessor from IBM, ARM processors from a variety of manufacturers, Sparc microprocessors from Sun Microsystems, Inc., PA-RISC series microprocessors from Hewlett-Packard Company, 68xxx series microprocessors from Motorola Corporation, and graphics processing units (GPUs) such as, for example, those from Nvidia or AMD.

The processor(s) 1201 of computer-based symbol sequence generation system 1200 may be any logic processing unit, such as one or more central processing units (CPUs), microprocessors, digital signal processors (DSPs), application-specific integrated circuits (ASICs), field programmable gate arrays (FPGAs), graphics processing units (GPUs), and/or the like. Unless described otherwise, the construction and operation of the various blocks shown in FIG. 12 may be presumed to be of conventional design. As a result, such blocks need not be described in further detail herein as they will be understood by those skilled in the relevant art.

The system bus 1210 in the computer-based symbol sequence generation system 1200 may employ any known bus structures or architectures, including a memory bus with memory controller, a peripheral bus, and/or a local bus. The system memory 1202 includes read-only memory (“ROM”) 1221 and random access memory (“RAM”) 1222. A basic input/output system (“BIOS”) 1223, which may or may not form part of the ROM 1221, may contain basic routines that help transfer information between elements within computer-based symbol sequence generation system 1200, such as during start-up. Some implementations may employ separate buses for data, instructions and power.

Computer-based symbol sequence generation system 1200 (e.g., system memory 1202 thereof) may include one or more solid state memories, for instance, a Flash memory or solid state drive (SSD), which provides nonvolatile storage of processor-executable instructions, data structures, program modules and other data for computer-based symbol sequence generation system 1200. Although not illustrated in FIG. 12, computer-based symbol sequence generation system 1200 may, in alternative implementations, employ other non-transitory computer- or processor-readable storage media, for example, a hard disk drive, an optical disk drive, or a memory card media drive.

Program modules in computer-based symbol sequence generation system 1200 may be stored in system memory 1202, such as an operating system 1224, one or more application programs 1225, program data 1226, other programs or modules 1227, and drivers 1228.

The system memory 1202 in computer-based symbol sequence generation system 1200 may also include one or more communications program(s) 1229, for example, a server and/or a Web client or browser for permitting computer-based symbol sequence generation system 1200 to access and exchange data with other systems such as user computing systems, Web sites on the Internet, corporate intranets, or other networks as described below. The communications program(s) 1229 in the depicted implementation may be markup language based, such as Hypertext Markup Language (HTML), Extensible Markup Language (XML) or Wireless Markup Language (WML), and may operate with markup languages that use syntactically delimited characters added to the data of a document to represent the structure of the document. A number of servers and/or Web clients or browsers are commercially available such as those from Google (Chrome), Mozilla (Firefox), Apple (Safari), and Microsoft (Internet Explorer).

While shown in FIG. 12 as being stored locally in system memory 1202, operating system 1224, application programs 1225, program data 1226, other programs/modules 1227, drivers 1228, and communication program(s) 1229 may be stored and accessed remotely through a communication network or stored on any other of a large variety of non-transitory processor-readable media (e.g., hard disk drive, optical disk drive, SSD and/or flash memory).

Computer-based symbol sequence generation system 1200 may include one or more interface(s) to enable and provide interactions with a user, peripheral device(s), and/or one or more additional processor-based computer system(s). As an example, computer-based symbol sequence generation system 1200 includes interface 1230 to enable and provide interactions with a user of computer-based symbol sequence generation system 1200. A user of computer-based symbol sequence generation system 1200 may enter commands, instructions, data, and/or information via, for example, input devices such as computer mouse 1231 and keyboard 1232. Other input devices may include a microphone, joystick, touch screen, game pad, tablet, scanner, biometric scanning device, wearable input device, and the like. These and other input devices (i.e., “I/O devices”) are communicatively coupled to processor(s) 1201 through interface 1230, which may include one or more universal serial bus (“USB”) interface(s) that communicatively couples user input to the system bus 1210, although other interfaces such as a parallel port, a game port or a wireless interface or a serial port may be used. A user of computer-based symbol sequence generation system 1200 may also receive information output by computer-based symbol sequence generation system 1200 through interface 1230, such as visual information displayed by a display 1233 and/or audio information output by one or more speaker(s) 1234. Monitor 1233 may, in some implementations, include a touch screen.

As another example of an interface, computer-based symbol sequence generation system 1200 includes network interface 1240 to enable computer-based symbol sequence generation system 1200 to operate in a networked environment using one or more of the logical connections to communicate with one or more remote computers (classical/digital or quantum), servers and/or devices (collectively, the “Cloud” 1241) via one or more communications channels. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, network interface 1240 may include one or more wired or wireless communications interfaces, such as network interface controllers, cellular radios, WI-FI radios, and/or Bluetooth radios for establishing communications with the Cloud 1241, for instance, the Internet or a cellular network.

In a networked environment, program modules, application programs or data, or portions thereof, can be stored in a server computing system (not shown). Those skilled in the relevant art will recognize that the network connections shown in FIG. 12 are only some examples of ways of establishing communications between computers, and other connections may be used, including wirelessly.

In accordance with the present systems, devices, and methods, computer-based symbol sequence generation system 1200 may include at least one quantum computer 1260. In the illustrated implementation of FIG. 12, quantum computer 1260 is communicatively coupled to processor 1201 and other components of system 1200 through the Cloud 1241, though a person of skill in the art will appreciate that in alternative implementations one or more quantum computer(s) may be communicatively coupled to other component(s) of system 1200 via direct wire connections or local wireless connections. Quantum computer 1260 may be operable to perform the various quantum computing acts described herein, including without limitation encoding, embodying, and/or executing the various quantum gates and quantum circuits described herein and, in some implementations, reading out quantum states as described herein. A person of skill in the art will appreciate that many different hardware configurations may be used as a suitable device for quantum computer 1260, including without limitation: a superconducting quantum computer such as those produced by IBM, Google, Amazon/Caltech, and Alibaba; a trapped ion quantum computer such as those produce by IonQ and Honeywell; a general purpose silicon photonic quantum computer such as those produced by PsiQuantum; or any of various other quantum computer technologies in development worldwide (such as quantum computers based on nuclear magnetic resonance, quantum dots, and so on). A person of skill in the art will appreciate that the present systems, devices, and methods are generic to and/or may be readily adopted for use with many different specific hardware configurations for quantum computing. In some implementations, the “quantum computer” portion of system 1200 may be conceptually treated as a “blackbox” from the perspective of a user of system 1200 with interactions between the user and quantum computer 1260 mediated by other components (such as processor 1201, memory 1202, and interface 1230) of system 1200. A person of skill in the art will appreciate that quantum computer 1260 may generally comprise a set of qubits with various communicative couplings therebetween (e.g., pairwise, nearest neighbor, couplings to a common resonator, etc.) depending on the specific processor architecture, as well as processor infrastructure for tunably configuring the initial state(s) of at least some qubit(s) and for reading out the state(s) of at least some qubits. Quantum computer 1260 may include local non-transitory storage media and/or communication infrastructure (e.g., electrical wiring with associated filtering) to relay control signals to qubits (and qubit-couplers if applicable) and to relay read-out signals from qubits. In some implementations, control signals relayed to the qubits of quantum computer 1260 may originate at and/or be defined by processor 1201 and/or read-out signals relayed from the qubits of quantum computer 1260 may be routed to (via one or more communicative couplings) processor 1201 for processing.

For convenience, processor(s) 1201, system memory 1202, interface 1230, and network interface 1240 are illustrated as communicatively coupled to each other via the system bus 1210, thereby providing connectivity between the above-described components. In alternative implementations, the above-described components may be communicatively coupled in a different manner than illustrated in FIG. 12. For example, one or more of the above-described components may be directly coupled to other components, or may be coupled to each other via intermediary components (not shown). In some implementations, system bus 1210 may be omitted with the components all coupled directly to each other using suitable connections.

In accordance with the present systems, devices, and methods, computer-based symbol sequence generation system 1200 may be used to implement or in association with any or all of methods 100, 200, 300, 600, 800, 900, 1000 and/or 1100 described herein and/or to encode, manipulate, vary, and/or generate any or all of the symbol sequence generations described herein. Generally, computer-based symbol sequence generation system 1200 may be deployed or leveraged to provide the symbol sequence generation capability described throughout this specification and the appended claims. Where the descriptions of methods 100, 200, 300, 600, 800, 900, 1000 and/or 1100 make reference to an act being performed by at least one processor or more generally by a computer-based symbol sequence generation system, such act may be performed by processor(s) 1201 and/or system memory 1202 of computer system 1200, individually or collectively or in conjunction with one or more quantum computer(s) 1260.

Computer system 1200 is an illustrative example of a system for performing all or portions of the various methods described herein, the system comprising at least one processor 1201, at least one non-transitory processor-readable storage medium 1202 communicatively coupled to the at least one processor 1201 (e.g., by system bus 1210), and the various other hardware and software components illustrated in FIG. 12 (e.g., operating system 1224, mouse 1231, etc.). In particular, in order to enable system 1200 to implement the present systems, devices, and methods for musical catalog amplification services, system memory 1202 stores a computer program product 1250 comprising processor-executable instructions and/or data 1251 that, when executed by processor(s) 1201, cause processor(s) 1201 to perform the various acts of methods 100, 200, 300, 400, and/or 500 that are performed by a computer-based symbol sequence generation system (e.g., accessing music, analyzing music, generating/varying music, and the like).

Throughout this specification and the appended claims, the term “computer program product” is used to refer to a package, combination, or collection of software comprising processor-executable instructions and/or data that may be accessed by (e.g., through a network such as cloud 1241) or distributed to and installed on (e.g., stored in a local non-transitory processor-readable storage medium such as system memory 1202) a computer system (e.g., computer system 1200) in order to enable certain functionality (e.g., application(s), program(s), and/or module(s)) to be executed, performed, or carried out by the computer system.

Some implementations of the present systems, devices, and methods may employ or exploit the teachings of US Patent Publication No. US 2021-0241734 A1, entitled “Systems, Devices, And Methods For Computer-Generated Musical Note Sequences”, which is incorporated herein by reference in its entirety, to learn a model from a library of exemplar songs, and then use that model to generate new songs. For example, a model may be encoded as a K-back probability transition matrix over a set of “riffled intervals” (as described in the US 2021-0241734 A1 patent publication incorporated by reference above) that provides a representation of multi-dimensional sequences, which is well-suited as a representation for music. To generate new music, a realization of the learned stochastic process model may be obtained from a given starting set of notes. However, to achieve certain musical objectives it might be necessary to re-run the generator multiple times. To combat this, and to allow more novel types of models of multi-track music, including the possibility of quantum correlated note sequences across tracks, a gate model quantum computer may be used in accordance with the present systems, devices, and methods. Even a “noisy intermediate-scale quantum era”, or NISQ-era” quantum computer may be acceptable for this application because, in some implementations, no exact answer is really needed. As long as the output roughly approximates the intended output, aesthetically pleasing musical results may be obtained in some implementations.

To encode simple stochastic process within a quantum circuit, a probability transition matrix, P, may be defined that describes a stochastic process over a set of 2\hat{ }k states. These states may include “riffled intervals”, but to the quantum computer these states may simply be treated as symbols. Such a matrix P may be learned from music samples (as described in the US 2021-0241734 A1 patent publication incorporated by reference above) and may have the form:

$$P = ( \begin{matrix}{p}_{0 , 0} & {p}_{0 , 1} & ⋯ & {p}_{0 , {2}^{k} - 1} \\ {p}_{1 , 0} & {p}_{1 , 1} & ⋯ & {p}_{1 , {2}^{k} - 1} \\ ⋮ & ⋮ & ⋱ & ⋮ \\ {p}_{{2}^{k} - 1 , 0} & {p}_{{2}^{k} - 1 , 2} & ⋯ & {p}_{{2}^{k} - 1 , {2}^{k} - 1}\end{matrix} )$$

where the row (column) indices correspond to the possible states of the process and each matrix element, {Pᵢⱼ}, which is non-negative with absolute value less than or equal to 1, gives the probability with which the state represented by index j will follow the symbol represented by index i in any realization of the stochastic process. To conserve probability, the rows may each sum to unity.

In general, such a matrix, P, may not be a unitary matrix and may not therefore be encoded directly as a natural quantum circuit. Nevertheless, a larger unitary matrix may be constructed that will impose the state to state transition probabilities contained within (the non-unitary) P as follows:
define each row of P as a separate matrix, P₀, to P_{2\hat{ }k-1}, whose leftmost columns are the square roots of the consecutive row values of matrix P, and whose remaining entries are all zeroes. For example, construct the matrices:

$${P}_{1} = ( \begin{matrix}\sqrt{{p}_{0 , 0}} & 0 & ⋯ & 0 \\ \sqrt{{p}_{1 , 0}} & 0 & ⋯ & 0 \\ ⋮ & ⋮ & ⋱ & ⋮ \\ \sqrt{{p}_{{2}^{k} - 1 , 0}} & 0 & ⋯ & 0\end{matrix} ) , \\ {P}_{2} = ( \begin{matrix}\sqrt{{p}_{0 , 0}} & 0 & ⋯ & 0 \\ \sqrt{{p}_{1 , 0}} & 0 & ⋯ & 0 \\ ⋮ & ⋮ & ⋱ & ⋮ \\ \sqrt{{p}_{{2}^{k} - 1 , 1}} & 0 & ⋯ & 0\end{matrix} ) , … , \\ {P}_{{2}^{k}} = ( \begin{matrix}\sqrt{{p}_{0 , {2}^{k} - 1}} & 0 & ⋯ & 0 \\ \sqrt{{p}_{1 , {2}^{k} - 1}} & 0 & ⋯ & 0 \\ ⋮ & ⋮ & ⋱ & ⋮ \\ \sqrt{{p}_{{2}^{k} - 1 , {2}^{k} - 1}} & 0 & ⋯ & 0\end{matrix} )$$

compute the singular value decomposition of each such matrix, Pᵢ, to yield a decomposition of the form:

Pᵢ=uᵢ·wᵢ·vᵢ^{†}
where “†” denotes conjugate-transpose.
form new auxiliary matrices, Uᵢ, which are, in fact, unitary matrices as:

Uᵢ=uᵢ·vᵢ^{†}
by omitting the central matrix.
form a new master “controlled” unitary matrix, U, as the direct sum of the unitary matrices Uᵢ, namely:

$$U = {U}_{0} ⊕ {U}_{0} ⊕ ⋯ ⊕ {U}_{{2}^{k} - 1} = ( \begin{matrix}{U}_{0} & 0 & ⋯ & 0 \\ 0 & {U}_{1} & ⋯ & 0 \\ ⋮ & ⋮ & ⋱ & ⋮ \\ 0 & 0 & ⋯ & {U}_{{2}^{k} - 1}\end{matrix} )$$

to yield a unitary matrix, and in turn a corresponding quantum circuit, that will enforce the symbol to symbol transitions of the probability transition matrix, P.
   As an example, as illustrated in FIG. 6, for the case of a 2\hat{ }k state process (with k=2 here), the direct sum matrix, U, is a 2\hat{ }(2k)×2\hat{ }(2k) dimensional unitary matrix, equivalent to a 2k-qubit quantum circuit, called the “Controlled-U gate” 600.

In Controlled-U gate 600, the qubits may be pictured as grouped into a first set of k “control” qubits and a subsequent set of k “target” qubits. The unitary matrix U may apply unitary operator Uᵢ to the k target qubits whenever the k control qubits contain the binary code for the integer i. Thus, the action performed on the target qubits may be conditioned on the values of the control qubits.

Returning to FIG. 7, by cascading such “Controlled-U” gates 600 in a staggered fashion, and measuring the output qubits in the computational basis, a quantum circuit may be designed that will yield a realization of the stochastic process encoded in a stochastic probability transition matrix P. In other words, quantum circuit 700 in FIG. 7 embodies 3 steps of a “1-back” stochastic process over a state space of 4 states, with each binary sequence of k bits associated with a “state”, and with the process seeded with a starting state 701 shown as state |φ [symbol] . Moreover, these “states” may be used to represent the riffled intervals (or other alternatives) from learned music.

Although quantum circuit 700 illustrated in FIG. 7 is an adequate formal drawing of a quantum circuit, to be practical, the given controlled quantum gates may be further reduced into sequences of 1-qubit and 2-qubit gates, specialized to the gates available in the particular quantum computer being used. Exemplary techniques to perform such gate reductions include the algebraic method based on the GSVD (generalized singular value decomposition) described in Williams, Colin; “Explorations in Quantum Computing”; Springer-Verlag London Limited 2011; pp 174-178 (DOI: https://doi.org/10.1007/978-1-84628-887-6), which may be used to design gate sequence simplification rules specific to the particular quantum computer being used.

In some implementations, results with better “musicality” may be obtained by going beyond a simple 1-back process. For example, FIG. 8 shows a quantum circuit 800 for 3 steps of a 2-back stochastic process over a state space of 4 states. That is, in quantum circuit 800 each next state of the process depends on the immediately preceding 2 states.

In some implementations, a probability transition matrix that is trained off a library of songs becomes a model for those songs. New songs may then be generated, that were not in the training set, by running the quantum model to make a superposition of all “songs” the model can generate from a starting state and then, following measurement, sample from that superposition to realize one “song”. Moreover, if the quantum computer (e.g., a NISQ-era quantum computer) is unable to be programmed with the full multi-step model, the measurement operators may be moved to earlier in the circuit and the realization of the whole stochastic process may be created iteratively, re-running one (or multiple) of the controlled-U gates at a time, seeding each next generation with the state(s) from the preceding generation.

Although classical computer science has efficient algorithms for generating realizations of certain kinds of stochastic processes, it does not have as efficient algorithms for generating all kinds of stochastic processes. For example, some processes, such as non-Markovian processes, non-stationary processes, and correlated processes, can be more computational demanding depending on the complexity of the model. However, in accordance with the present systems, devices, and methods, quantum computing may be used to create stochastic process simulators that efficiently generate realizations of stochastic processes for which there is no known efficient algorithm to do so classically. For example, FIG. 9 shows an implementation of a non-stationary stochastic process in accordance with the present systems, devices, and methods. In quantum circuit 900, the probabilistic transition matrix is allowed to change (i.e., U->V->W in FIG. 9) across successive steps in a realization of the process.

Similarly, FIG. 10 shows an implementation of the present systems, devices, and methods in which the quantum circuit 1000 comprises three (3) steps of a pair of tunably correlated stochastic processes (U, V) with the same control variables used to determine two (or more) state sequences, corresponding to multiple tracks of music. Even though the control qubits are, in this case, common to both tracks the probability transition matrices they drive (implemented as Controlled-U and Controlled-V gates in the exemplary case) need not be the same.

FIG. 10 shows an implementation of a quantum circuit 1000 for generating realizations of correlated stochastic processes wherein the state transitions of both sequences may be governed by common control qubits, or more generally, by entanglement between the stochastic processes on each track. In accordance with the present systems, devices, and methods, a quantum circuit may be designed, developed, or otherwise defined to generate multiple tracks of note sequences with entanglement imposed between the tracks by using entangling quantum gates and measurement bases of various qubits may be selected so as to maximize quantum correlations between tracks. Indeed, returning to FIG. 2, any (n k)-qubit quantum circuit such as quantum circuit 200 may be viewed as a sequence generator for n “states”, each state specified by k bits. In accordance with the present systems, devices, and methods, associating these n states with n musical abstractions allows a wide range of quantum circuits to be used to make music. Thus, the various implementations described herein improve the function of computer systems in generating music by using quantum computing resources to enable efficient generation of stochastic processes that are not otherwise accessible by classical computing resources alone.

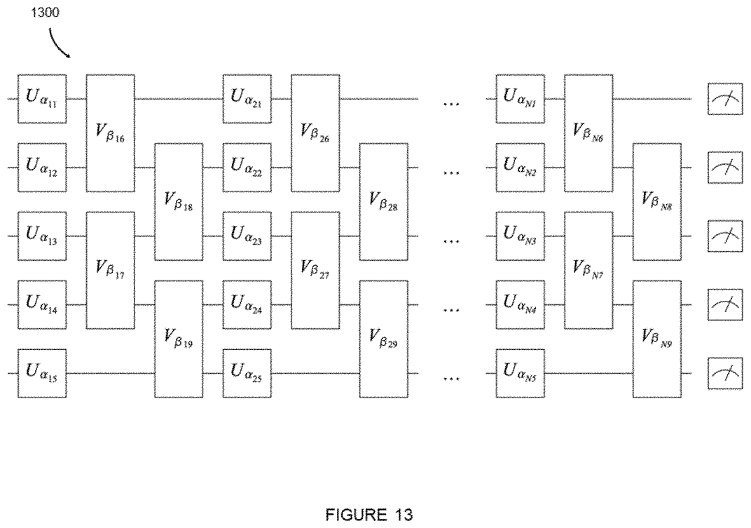

In some implementations of the present systems, devices, and methods, a parameterized quantum circuit may be trained on a library of exemplar songs so that the quantum circuit itself becomes a de facto quantum generator of new songs given some canonical input such as all qubits being set in the |0 [symbol] state. To train the circuit, an iterative process may be constructed that minimizes the difference between the distribution of songs produced by the model (with inputs all |0 [symbol] ) and the distribution of songs seen (empirically) within the training set. At each iteration, the model may be specified by some instantaneous quantum circuit, i.e., some instantaneous configuration of gates and their parameters. Running this circuit several times may generate data from which a model distribution may be constructed. The distance between the model distribution and the empirical distribution, as measured by, for example, their KL-divergence may be quantified. The model parameters may be adjusted, e.g., by using a gradient descent technique, or a gradient-free technique, so as to drive this KL-divergence to a lower value. The process may be terminated with success when the model distribution and empirical distributions are sufficiently close, or with failure if a satisfactory model is not found within some bound on the number of iterations. An outline for the structure of a candidate quantum circuit for such an approach is shown in FIG. 13.

FIG. 13 shows the notional structure for an exemplary parameterized quantum circuit 1300 that can be trained to generate music in accordance with the present systems, devices, and methods. In the implementation of circuit 1300, the U gates are 1-qubit gates, which could correspond to sequences of, e.g., single rotations, and the V gates are 2-qubit entangling gates. Each U gate is associated with a set of “α” parameters and each V gate is associated with a set of “β” parameters that specify their form. In general, the parameters for each gate could be different and may change over the course of training. Some candidate 2-qubit gates would be controlled-NOT, controlled-Z, or iSWAP gates raised to some variable fractional power. However, other 2-qubit gates could be used too. Depending on the specific implementation, both the parameter values may be varied alone or the quantum circuit topology may be varied with both the parameter values. An advantage of a quantum learning approach to quantum music-making is that the approach may be adapted to accommodate whatever quantum circuit structures are feasible to realize within available NISQ-era quantum computer hardware.

In accordance with the present systems, devices, and methods, music of a new kind (compared to music generated by conventional methodologies) may be generated by exploiting various types of quantum correlations. For example, in some implementations, the present systems, devices, and methods may be employed to generate note sequences that are correlated via quantum entanglement.

Specifically, a note of an arbitrary key and scale may be associated with an integer and the integer may be represented by a sequence of bits. Quantitatively, k bits can represent 2\hat{ }k integers, therefore k bits can represent 2\hat{ }k notes. It follows that a set of m ordinally synchronized note sequences (for example, each corresponding to a respective track of a musical composition) can be represented as a set of m ordinally synchronized integers. In the exemplary case of m=2 (i.e., two note sequences each corresponding to a respective one of two tracks), an entangled quantum state of 2k qubits may be created wherein, conceptually, qubit 1 is entangled with qubit 2, qubit 3 is entangled with qubit 4, and so on; i.e., qubit (2j−1) is entangled with qubit 2j. The entangling may be done by means of an “entangling 2-qubit gate” whose entangling power is controllable by a parameter to be any value in the range 0 (not entangling at all) to 1 (maximally entangling). The entangling power of a 2-qubit gate may be characterized exactly mathematically, so a sequence of k (real and positive) parameters may be used to specify the entangling power of a sequence of 2-qubit gates. Forming a first integer from all the k “odd” indexed qubits and a second integer from all the k “even” indexed qubits yields two integers whose qubits are pairwise entangled. This approach may be extended to the formation of two sequences of integers (i.e., a first sequence of integers and a second sequence of integers), wherein each pair of integers in corresponding places in the respective first and second sequences are entangled. These two sequences of entangled integers may be representative of two sequences of entangled notes by using the integer to note mapping described above. In some implementations, a quantum computer may be prepared in a quantum state corresponding to such a pair of entangled note sequences. In this case, reading out the qubits generates a pair of note sequences that may be played by assuming some timing for each note of each sequence and an inter-note time offset from the beginning of a first note in a given note sequence to the successor note in the same sequence. In some implementations, the pair of note sequences may be played according to a timing borrowed or copied from another musical composition. Thus, the process outlined above enables musical note sequences to be generated by a quantum computer. Generalizations to m>2 tracks are possible, for example, either using a plurality of 2-qubit entangling gates or n-qubit entangling gates (for any n from 2<n<=m).

An example of utilizing the foregoing to produce music of a new kind (compared to music generated by conventional methodologies) is as follows: for a pair of entangled note sequences |S_12> corresponding to a pair of tracks 1 and 2, the sound of note sequences created from |S_12> and sequences created form (R(theta)×R(phi)) |S_12> (where R(theta) and R(phi) are 1-qubit rotations and “x” means “direct product”, also known as “tensor product” or “Kronecker product”) may be explored. By varying the rotation angles theta and phi the two note sequences may be demonstrably quantum correlated, which may be correlated more strongly than is possible classically and therefore results in musical sequences of a sort that is not obtained classically.

In some implementations of the present systems, devices, and methods, classical random walks and quantum walks are employed to generate musical sequences, for example, sequences of chords or notes. Classical random walks may be used to generate symbol sequences by associating the position of the walker over a finite set of positions with a corresponding finite set of symbols. That is, the walk process may start from some initial position (i.e., symbol) and records the positions (symbols) visited along the walk.

Quantum walks are the quantum mechanical analogs of classical random walks. However, whereas classically the position of the walker is described by a probability distribution, in a quantum walk the position of the walker is described by a quantum superposition whose component eigenstates represent the different possible positions of the walker. The position of the walker may be unknown unless and until this superposition state is measured. At that instant the position of the walker becomes known and definite.

Mathematically, the quantum walk process may be described by the application of a unitary operator. This unitary operator U may be broken down into a pair of simpler unitary operators, one representing a quantum coin toss and one representing a quantum move conditioned on that coin toss. Hence, starting with some initial position, a coin may be tossed and a corresponding conditional move enacted. However, because this is a quantum process it may not be necessary or feasible to measure at every step. Rather, quantum walking may continue from an initial state by alternating quantum coin toss unitary operators with quantum conditional move unitary operators without reading the coin outcome each time. By avoiding measuring, quantum mechanical interference can allow certain eigenstates (equivalent to walker positions) to develop large amplitudes (corresponding to more likely positions if the superposition were to be measured) and other eigenstates to develop low amplitudes (corresponding to unlikely positions if the superposition were to be measured). Such quantum mechanical interference may cause the position of the quantum walker after N steps of the process to be very different from the position of the analogous classical walker after N steps of the analogous classical process, leading to a faster spreading of the final position distribution in the quantum case compared to the classical case. For example, it is often the case that a quantum walk diffuses quadratically faster than its corresponding classical counterpart. This means that after a given number of steps of the walk, the quantum walker can be farther from the starting point than can the classical walker. This means that a quantum walk process may achieve a qualitatively different symbol sequence compared to that which we would obtain classically and therefore, according to the present systems, devices, and methods, produce sequences of musical events (e.g., notes, chords, key modulations, and so on) that may not be produced by classical musical composition algorithms alone.

Furthermore, by modifying the quantum walk process to include the states visited during the walk, a whole sequence of N positions visited may be obtained upon measuring the final superposition after N repetitions of quantum coin toss and quantum conditional move. Associating these N positions with N different symbols may enable the use of a quantum walk to generate symbol sequences.

In some implementations, quantum or classical walks may be constrained to occur on graphs. An illustrative case is that of quantum or classical walks on “chord graphs”. Chord graphs are graphs whose vertices are chords (e.g., Cmaj, Abmin) and whose (possibly directed or undirected) edges represent the musically aesthetic allowed transitions between chords. Creating quantum or classical walks on such chord graphs generates sequences of chords that may be, in the simplest case, sequentially nearest neighbors to one another, within the chord graph, specifically, sequences of chords such that each successor chord in the sequence is directly connected to its predecessor in the chord graph. However, some implementations may also allow for moves from one chord to a next nearest neighbor chord (i.e., chords that are two edges distant from the first chord) and/or moves from one chord to a next nearest neighbor chord (i.e., chords that are 3 edges distant from a first chord).

The various implementations described herein include systems, devices, and methods that employ and/or generate sequences of symbols, where the symbols may correspond to musical events such as chords. In particular implementations of the present systems, devices, and methods, the symbol sequences that are generated correspond to musical chord progressions (i.e., sequences of chords that are musically/aesthetically pleasing). As described above, a symbol sequence (e.g., a chord progression) may be generated by a walk process (classical or quantum). For the purposes of illustration, the various implementations of walk processes described herein may be represented in graphical form.

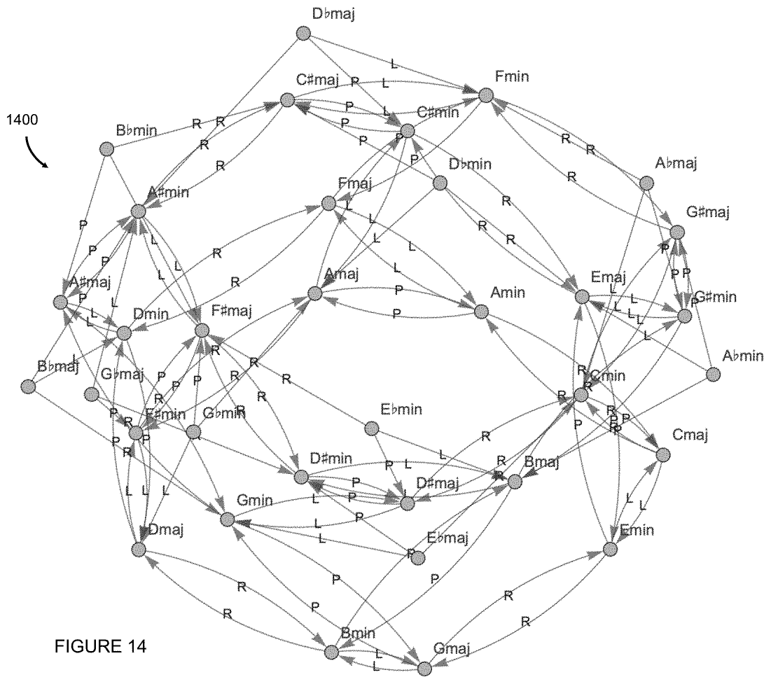

FIG. 14 is an illustrative diagram of a chord graph 1400 upon which a quantum or classical walk may be performed showing available chord progressions (subject to conventional rules of music theory) for major and minor triad chords allowing parallel (P), relative (R), and leading-tone (L) transformation exchanges. In accordance with the present systems, devices, and methods, each node of graph 1400 corresponds to a position/symbol and a chord progression may be generated by a walk process (be it classical or, in some cases advantageously, quantum) that follows the allowed P, L, and R connections illustrated to produce a sequence of positions/symbols. For example, a nearest-neighbor walk process starting at Db-maj in graph 1400 may produce the sequence: Db-maj; C♯-min; F-min; G♯-maj; and so on.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method to generate a sequence of symbols from a set of symbols, the method comprising:
defining a correlation structure between symbols in the set of symbols;
defining a mapping between quantum states and symbols in the set of symbols;
embodying the correlation structure in a quantum circuit;
inputting an initial quantum state to the quantum circuit;
running the quantum circuit;
reading out a final quantum state; and
applying the mapping between quantum states and symbols to obtain the symbol sequence.

2. The method of claim 1 wherein embodying the correlation structure in a quantum circuit includes embodying the correlation structure in a quantum circuit described, at least in part, by a unitary matrix.

3. The method of claim 1 wherein the method is performed by a computer system comprising at least one processor and at least one quantum computer communicatively coupled to the at least one processor, and wherein:
defining a correlation structure between symbols in the set of symbols includes defining the correlation structure by the at least one processor;
defining a mapping between quantum states and symbols in the set of symbols includes defining the mapping by the at least one processor;
embodying the correlation structure in a quantum circuit includes embodying the correlation structure in the quantum circuit by the quantum computer;
inputting an initial quantum state to the quantum circuit includes inputting the initial quantum state to the quantum circuit by the quantum computer;
running the quantum circuit includes running the quantum circuit by the quantum computer;
reading out a final quantum state includes reading out the final quantum state by the quantum computer; and
applying the mapping between quantum states and symbols to obtain the symbol sequence includes applying the mapping between quantum states and symbols by the at least one processor.

4. The method of claim 1 wherein inputting an initial quantum state to the quantum circuit includes inputting an initial quantum state that represents an initial symbol from the set of symbols according to the mapping.

5. The method of claim 4 wherein inputting an initial quantum state that represents an initial symbol from the set of symbols according to the mapping includes inputting a tensor product between the initial symbol from the set of symbols and a starting state.

6. The method of claim 1 wherein defining a correlation structure between symbols in the set of symbols includes learning the correlation structure from a training set of exemplary symbol sequences.

7. The method of claim 1 wherein defining a correlation structure between symbols in the set of symbols includes defining the correlation structure as a unitary matrix, and wherein embodying the correlation structure in a quantum circuit includes embodying the correlation structure in a sequence of single qubit and multi-qubit quantum gates that embodies the unitary matrix.

8. The method of claim 1 wherein reading out a final quantum state includes reading out the final quantum state in the computational basis.

9. The method of claim 1 wherein the set of symbols includes a set of musical events.

10. The method of claim 9 wherein the set of symbols includes at least one musical event selected from a group consisting of: a musical note, a musical chord, a musical percussion strike, a musical time interval, a musical note interval, and a musical key.

11. The method of claim 9 wherein defining a correlation structure between symbols in the set of symbols includes defining a correlation structure between musical events in the set of musical events.

12. The method of claim 11 wherein defining a mapping between quantum states and symbols in the set of symbols includes defining a mapping between quantum states and musical events in the set of musical events.

13. The method of claim 12 wherein applying the mapping between quantum states and symbols to obtain the symbol sequence includes applying the mapping between quantum states and musical events to obtain a sequence of musical events.

14. The method of claim 13 wherein the set of musical events includes a set of musical chords, and wherein applying the mapping between quantum states and musical events to obtain a sequence of musical events includes applying the mapping between quantum states and musical events to obtain a musical chord progression.

15. The method of claim 13 wherein the set of musical events includes a set of musical keys, and wherein applying the mapping between quantum states and musical events to obtain a sequence of musical events includes applying the mapping between quantum states and musical events to obtain a sequence of musical key modulations.

16. The method of 9 wherein defining a correlation structure between symbols in the set of symbols includes defining a graph with each node corresponding to a respective musical event and each edge corresponding to a respective allowed transition between a respective pair of musical events, and wherein running the quantum circuit includes performing a quantum walk process on the graph.

17. The method of claim 16 wherein applying the mapping between quantum states and symbols to obtain the symbol sequence includes applying the mapping between quantum states and musical events to obtain a sequence of musical events corresponding to a walk process that starts at a musical event corresponding to the initial quantum state and progresses to successive musical events following allowed transitions according to the edges of the graph.

18. A computer system comprising:
at least one processor;
at least one quantum computer communicatively coupled to the at least one processor; and
a non-transitory processor-readable storage medium communicatively coupled to the at least one processor, the non-transitory processor-readable storage medium storing a set of symbols and processor-executable instructions that, when executed by the at least one processor, cause the computer system to:
embody a correlation structure between symbols in the set of symbols in a quantum circuit;
input an initial quantum state to the quantum circuit;
run the quantum circuit;
read out a final quantum state; and
apply a mapping between quantum states and symbols in the set of symbols to obtain a symbol sequence.

19. The computer system of claim 18 wherein the set of symbols includes a set of musical events and the processor-executable instructions that, when executed by the at least one processor, cause the computer system to apply a mapping between quantum states and symbols in the set of symbols to obtain a symbol sequence, cause the computer system to apply the mapping between quantum states and musical events to obtain a sequence of musical events.

20. The computer system of claim 19 wherein the processor-executable instructions that, when executed by the at least one processor, cause the computer system to embody a correlation structure between symbols in the set of symbols in a quantum circuit, cause the computer system to embody the correlation structure between musical events in a quantum circuit described, at least in part, by a unitary matrix.
